(19) United States
(12) Patent Application Publication
(10) Pub. No.: US 2025/0315377 A1
(43) Pub. Date: Oct. 9, 2025

(54) HYBRID-PAGING

(71) Applicant: NETLIST, INC., Irvine, CA (US)

(72) Inventor: Jordan HORWICH, Corona, CA (US)

(21) Appl. No.: 19/169,783

(22) Filed: Apr. 3, 2025

Related U.S. Application Data
(60) Provisional application No. 63/574,478, filed on Apr. 4, 2024.

(51) Int. Cl. G06F 12/02; G06F 12/1009; G06F 13/40; G06F 13/42

(52) U.S. Cl. CPC G06F 12/0246; G06F 12/1009; G06F 13/4022; G06F 13/4282; G06F 2212/7201

(57) ABSTRACT

Examples are disclosed herein relating to memory paging. In some examples, a host device is configured to communicate with an expansion device. The expansion device can include first and second memory, and a device virtual memory address (DVA) table. The expansion device can store data that can be requested by the host device. The first memory is a cache for the second memory based on a page presence table (PPT). The PPT can indicate a presence of second memory pages in the first memory cache. The DVA table can include information to locate data in the first memory based on a host physical memory address of a memory request. The device physical memory address can identify a memory location at which the data is stored. The data can be provided from the expansion device to the host device in response to the memory request based on the PPT.

### FIELD OF THE DISCLOSURE

This disclosure relates generally to memory management, and more particularly, to memory paging.

### BACKGROUND OF THE DISCLOSURE

Virtual memory management (demand paging) is a memory management technique used to map various memory and storage resources that are available on a given machine into a common linear address space, which creates an illusion to users of a large (main) memory. Virtual memory makes application programming easier by hiding fragmentation of physical memory; by delegating to a kernel of an operating system (OS) management of memory hierarchy (eliminating a need for a program to handle overlays explicitly); and, when each process (or application) is run in its own dedicated address space, by obviating the need to relocate program code or to access memory with relative addressing. Memory paging (or swapping on some Unix-like systems) is a memory management scheme by which a computer accesses data from a secondary storage for use in main memory.

Mechanisms have been developed to ensure that data shared across different memory locations is up to date (e.g., coherent). For example, a cache coherency mechanism can be used, such as from a Compute Express Link (CXL). CXL is an emerging high-speed interconnect technology designed to enhance the performance and flexibility of data center and high-performance computing (HPC) systems. CXL provides a unified interconnect framework that allows different processors, accelerators, and memory devices to communicate and share resources efficiently. CXL includes cache coherency mechanisms to ensure that data stored in caches across different devices remains consistent, even in multi-device configurations. Cache coherency in CXL ensures that data stored in caches across different devices remains consistent and up-to-date, even when multiple devices access shared memory or data structures. CXL is designed to enable high-speed communication and resource sharing between various processors and accelerators within a data center or system. Cache coherency mechanisms in CXL help manage the complexities of sharing data and maintaining consistency across these different devices.

### SUMMARY OF THE DISCLOSURE

Various details of the present disclosure are hereinafter summarized to provide a basic understanding. This summary is not an extensive overview of the disclosure and is neither intended to identify certain elements of the disclosure nor to delineate the scope thereof. Rather, the primary purpose of this summary is to present some concepts of the disclosure in a simplified form prior to the more detailed description that is presented hereinafter.

In an example, a method for configuring a host device for hybrid-paging (HPG) can include setting enabling bits of system registers of the host device to configure the host device to operate in a HPG mode, setting configuration bits of the system registers to define operational parameters for the HPG mode, setting table bits of the system registers for generating a page presence table (PPT), an generating the PPT based on the table bits, the PPT being used to access data at an expansion device for the host device.

In another example, a method for accessing data for a host device from an expansion device can include configuring the host device for HPG, generating a memory request for the data stored at the expansion device. The expansion device can include first memory and second memory. The first memory functions as a cache for the second memory based on a PPT. The PPT can indicate a presence of memory pages in the first memory for the second memory. The method can further include converting a host physical memory address (HPA) of the memory request to a device virtual memory address (DVA), converting the DVA to a device physical memory address (DPA) to identify a memory location within the first memory at which the data is stored, and providing the data to the host device based on the identified memory location.

In yet another example, a system can include a host device that communicates with an expansion device. The host device can be configured to execute configuration code to set bits of system registers of the host device to configure the host device for HPG. The configuration of the host device for HPG can include generating a page presence table (PPT) in response to executing the configuration code. The PPT can indicate a presence of memory pages in a first memory of the expansion device for a second memory of the expansion device. The host device can be configured to receive the data stored at the expansion device based on the PPT.

In an even further example, an expansion device can include first memory, second memory, and a PPT. The PPT can indicate a presence of one or more pages of the second memory in the first memory. The expansion device can further include a device virtual memory address (DVA) table that can specify a placement of the one or more pages of the second memory in the first memory and a DPA that can identify a memory location in the second memory for accessing data. The expansion device can further include a cache memory controller to manage access to the data in the second memory based on the PPT and the DVA table.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

Embodiments are described with reference to the accompanying drawings. In the drawings, like reference numbers can indicate identical or functionally similar elements. The drawing in which an element first appears is generally indicated by the left-most digit in the corresponding reference number.

FIG. 1 is an example of a system implementing hybrid-paging (HPG).

FIG. 2 is an example of a block diagram of a computer system.

FIG. 3 is an example of a CR0 register bit map table.

FIG. 4 is an example of a CR0 register bit description table.

FIG. 5 is an example of a CR4 register bit map table.

FIG. 6 is an example of a CR4 register bit description table.

FIG. 7 is an example of a CR3 register bit map table.

FIG. 8 is an example of a memory page granularity (MG) table indicating a page granularity of the PPT.

FIG. 9 is an example of a CR5 register bit map table.

FIG. 10 is an example of CR3 and CR5 register bit description tables.

FIG. 11 is a simplified example of a hardware (H/W) management technique for invalidating a cache hierarchy of a host device.

FIGS. 12A-12B is an example of using a page presence table (PPT) or a page presence entry (PPE) for retrieving data stored at an expansion device.

FIG. 13 illustrates a host PPT caching rules table for host-device side caching of a PPT.

FIG. 14 is an example of a PPT.

FIGS. 15-22 are examples of mappings of device physical address (DPA) space space into a host physical memory address (HPA) space.

FIG. 23 is an example of a CR2 register bit map table.

FIG. 24 is an example of a CR2 register bit description table.

FIG. 25 is an example pseudocode for configuring system registers for invoking a page fault.

FIG. 26 is an example of pseudocode for implementing a hybrid page fault handler.

FIG. 27 is an example of a method for enabling a host device to operate in a HPG mode.

FIG. 28 is an example of a method for accessing data from an expansion device using HPG.

### DETAILED DESCRIPTION

Embodiments of the present disclosure will now be described in detail with reference to the accompanying Figures. In the following detailed description of embodiments of the present disclosure, numerous specific details are set forth in order to provide a more thorough understanding of the claimed subject matter. However, it will be apparent to one of ordinary skill in the art that the embodiments disclosed herein can be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Examples are disclosed herein relating to memory-paging that does not require use of a host page-directory or host page-table, but rather offloads paging management to a memory expansion device through use of a device-side page presence table (PPT). A memory management scheme, referred to as hybrid-paging (HPG), is disclosed herein that enables a host device to access data from an expansion device based on the PPT. Accessing data can include reading a memory location to retrieve the data, or writing to the memory location to store the data, for example, of an expansion device. HPG uses a distributed paging protocol that can consist of one or more host-side paging agents (referred to herein as “hosts” or “host devices”) and one or more device-side paging agents (referred to herein as “expansion devices” or in some instances as “caching memory controller devices”). The distributed paging protocol off-loads address translation to an expansion device, such that resources of the host device can be freed up for other processing. The PPT enables the host device to perform address translation without a table walk. A table walk, in context of computer memory management, is a process of translating a virtual memory address to a physical memory address using one or more page tables according to a page directory. The table walk begins at a highest level (e.g., a page global directory) and “walks” down to lower levels to translate the virtual memory address to the physical memory address. If a translation exists from the virtual memory address to the physical memory address, this is referred to as a hit (e.g., a dynamic random-access memory (DRAM hit). If the translation from the virtual memory address to the physical memory address does not exist, this is referred to as a miss (e.g., DRAM miss).

The host-side paging agent and one or more device-side paging agents can be coupled through a shared coherent memory structure, a respective PPT. In some examples, a device-side paging agent is a CXL Type 2 or Type 3 Memory Expander (MX) device that can include at least two (2) tiers of memory, where Tier 1 memory acts as a cache for Tier 2 memory. The PPT can indicate a presence or absence of Tier 2 memory pages in the Tier 1 memory (in some instances referred to as “Tier 1 Cache”.) The device-side paging agent can maintain the PPT while the host-side paging agent can observe the PPT (or some portion thereof, which can be referred to as a page presence entry (PPE)). By using HPG, a host agent can manage the performance of one or more high-latency tiered-memory operations. The host-side paging agent is a virtual memory management unit (VMMU) that can be a hardware component of the host device that can observe and act upon content of one or more PPTs. In some instances, the VMMU can be enabled at an Operating System (OS) layer or level, for example, as part of a kernel of the OS, or in other examples, outside of the kernel of the OS.

In examples in which the host-side paging agent is implemented according to an x86 architecture, the host-side paging agent can assert or issue a doorbell write to the expansion device for a memory operation that would hit on a page marked as not present in the PPT. In some examples, the host-side paging agent can use host-side signaling, which can use a side-band communication channel. The host-side signaling can issue or assert the doorbell, an interrupt, a mailbox, or a coherency mechanism (e.g., such as monitor/mwake, etc.). The host-side paging agent (or VMMU) can be implemented according to a computer architecture (or central processing unit (CPU) architecture). Example computer architectures on which the host-side paging agent can be based can include, but not limited to, an ARM architecture, a PowerPC architecture, a MIPS architecture, and RISC-V architecture, etc. The host-side paging agent can issue a doorbell write to the expansion device based on its computer architecture. Each device-side paging agent can maintain a PPT, and this table indicates a presence and absence of Tier 2 capacity in Tier 1 memory for that device-side paging agent.

By way of example, a host device (e.g., a microprocessor) can be configured for hybrid-paging. To configure the host device, enable bits of system registers of the host device are set to operate the host device in HPG mode, configuration bits of the system registers are set to define operational parameters for the HPG mode, and table bits (or table pointer bits) of the systems registers are set to identify a location for a PPT. The PPT can be used by the host device to access data (e.g., control structures) provided by one or more expansion devices.

By way of further example, to enable a host device to access data from an expansion device the host device is configured for HPG. The host device can generate a memory request for data stored at the expansion device. The expansion device can include Tier 1 memory, Tier 2 memory, a PPT, and a device virtual memory address (DVA) table. The Tier 1 memory is a cache (e.g., page cache) for the Tier 2 memory. The PPT reflects a presence of Tier 2 memory pages within the Tier 1 memory. The PPT can be observed by the host device. A host memory request can be generated at the host device for data present in the Tier 1 memory. If the data is present in the Tier 2 memory this can be referred to as a hit (e.g., DRAM hit), whereas if the data is not present in the Tier 2 memory this can be referred to as a miss (e.g., DRAM miss). The DVA table can identify a memory page in the Tier 1 memory at which a Tier 2 memory page can be cached. The expansion device uses the DVA table to translate each host device memory request (Tier 2) address into its associated Tier 1 memory address, when the referenced Tier 2 memory is present (cached) in Tier 1 memory. The data from the expansion device can then be provided to the host device in response to the host memory request.

In further examples, a system can include a host device that communicates with an expansion device. The host device can be configured to enable a virtual memory management unit (VMMU) to operate in HPG mode by setting bits of system registers of the host device. HPG configuration enables the VMMU to observe one or more PPTs. Each PPT indicates the presence or absence of Tier 2 memory pages in Tier 1 Cache(s) of a respective expansion device. The VMMU can notify the expansion device regarding memory operations that hit on memory pages marked as not present in a PPT. Device-side paging agents can intercept and resolve these page faults. The host device can be configured to receive data stored at the expansion device based on the PPT.

In additional or alternative examples, an expansion device can include device near memory (DNM), device far memory (DFM), a page presence table (PPT), and a device virtual memory address (DVA) table. The PPT can indicate the presence of memory pages of the DFM in the DNM. When a page of the DFM is present in the DNM, the DVA table can indicate (identify) a physical address in the DNM where the DFM page data is cached. The expansion device can include a cache memory controller to manage access to the data in the DNM.

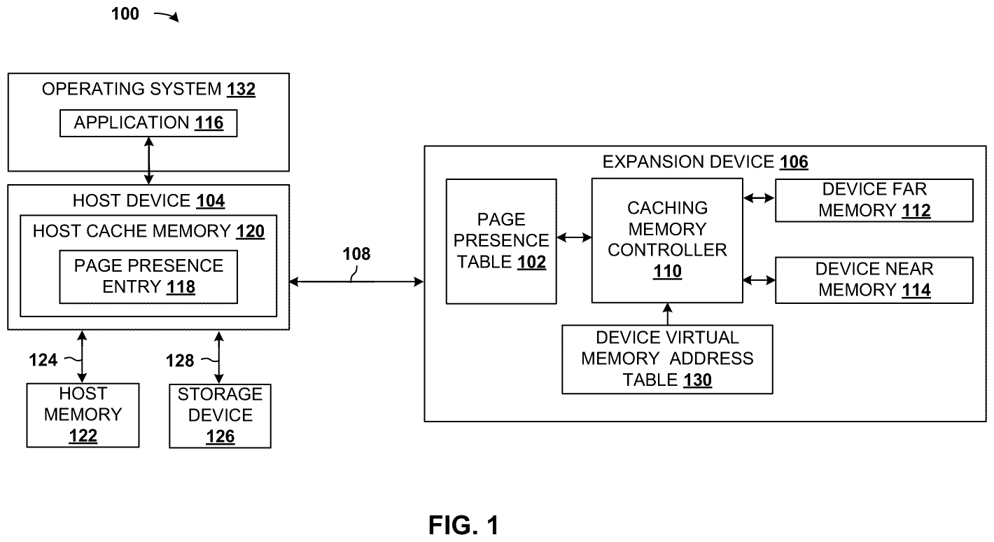

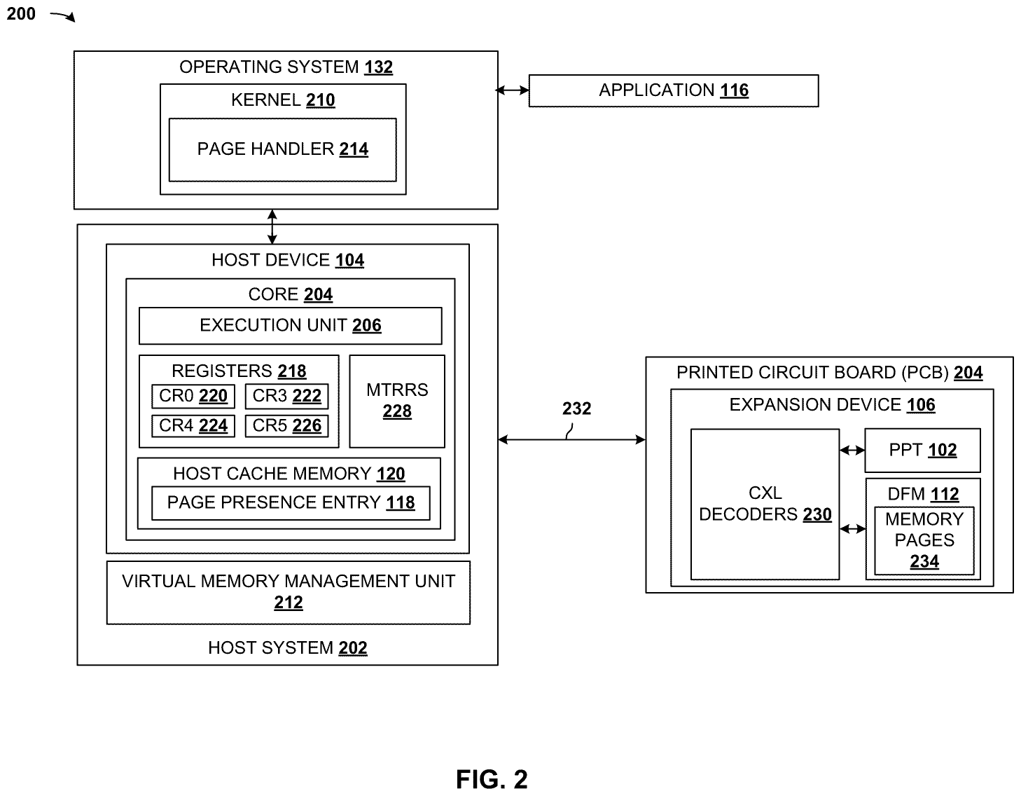

FIG. 1 is an example of a block diagram of a system 100 implementing HPG. The term “hybrid-paging” or “HPG” as used herein refers to a memory management scheme by which a host device accesses data from an expansion device based on a PPT. For example, the data can be accessed through a memory request, which can be generated (or issued) in response to (or by) an application (or program) 116 executing on a host device 104, or an OS 132 (or an OS's kernel). Memory request (or virtual memory request or access) refers to an action of reading from or writing to one or more memory locations, which can include a memory location of an expansion device 106. For example, the application 116, when it needs to access memory (e.g., cache coherent memory, which can include device far memory (DFM) 112 of the expansion device 106, as shown in FIG. 1)—for instance, to read data (or content of a memory location) or modify the data (e.g., a data structure at a memory location)—it can specify a particular memory address. A memory address is a specific location within an application's address space or host physical address (HPA) space. The expansion device 106 can organize data within its device near memory (DNM) 114 and its device far memory 116 (DFM) as memory pages (e.g., memory pages 234, as shown in FIG. 2). A page is a fixed-length block of memory. A host physical address can include a page number and an offset within that page. The page number can identify which page of the DFM 114 the HPA belongs to. The offset can specify an exact location within that page. The host device 104 can use the HPA to identify the page of DFM 114 to which the memory address belongs. Once the page has been identified, a PPT 102 can be used by the host device 104 to determine whether the page is present or absent from the DNM 114.

The memory request issued by the application 116 can be expressed in terms of a host virtual memory address (HVA), as the application 116 operates within its own virtual address space provided by the OS 132. The OS 132 can configure the host device 104 to translate a HVA to a host physical memory address (HPA). The host device 104 can translate the HVA (e.g., a high-level virtual memory request as its issued by the application 116) into the HPA (e.g., an HPA that can be processed or understood by hardware, the host device 104, and/or the expansion device 106). For example, the host device 104 can generate an HPA from an HVA, determine whether the HPA is targeting the DFM 112 of the expansion device 106, and if so, can use the PPT 102 (or a portion thereof, such as a PPE) 118) to determine whether the HPA is present or absent from within the DNM 114 of the expansion device 106. In some examples, before forwarding the memory request with the HPA to the expansion device 106, The Host Device 104 interrogates the PPT 102 (or the PPE 118). In response to the page being present in the DNM 114, the host device 104 can communicate with the expansion device 106 (according to one or more examples, as disclosed herein) to retrieve data from or write data to a (HPA) memory location (or locations) in the expansion device 106. In response to the page being absent from the DNM 114, the host device 104 can communicate with the expansion device 106 (according to one or more examples, as disclosed herein) to copy (or cache) data from the DFM 112, as indicated by a (HPA) memory location (or locations) to DNM 114 of the expansion device 106.

As shown in FIG. 1, the system 100 includes the host device 104 (whose operation can be referred to in terms of a host-side paging agent) and the expansion device 106 (whose operation can be referred to in terms of a device-side paging agent). While the example of FIG. 1 illustrates a single expansion device, in other examples the system 100 can include any number of expansion devices. The host device 104 and the expansion device 106 can communicate over (or using) a communication channel (or bus) 108. In some examples, the communication channel 108 is a communication bus. Thus, in some examples, the host device 104 and the expansion device 106 can communicate according to a communication standard, such as a Compute Express Link (CXL) protocol. CXL is a protocol that runs across or using a PCI Express (PCIe) physical layer and introduces a protocol for managing data coherency and memory semantics. In some examples, the communication channel 108 can be used to establish a link between the host device 104 and the expansion device 106, such as a CXL link. The communication channel 108 can include one or more extension devices. The link may conform to a communication standard (e.g., a CXL standard). A link can be a serial point-to-point communication link that allows ports at ends of the link to send and receive information (referred to as messages). Thus, at a physical level, a link can include one or more lanes. A lane can include two differential wire pairs, one receiving and transmitting pair, and thus one lane can include four (4) wires. By way of example, an “x4” link can include 4 lanes (e.g., 16 wires), an “x16” link can include 16 lanes (e.g., sixty-four (64) wires), and an “x32” link can include 32 lanes (e.g., 128 wires). For example, to scale bandwidth, a link may aggregate multiple lanes denoted by xN, wherein N is any supported link width, such as 1, 2, 4, 8, 12, 16, 32, 64, or wider. In other examples, the communication channel 108 can include a greater or fewer number of lanes as described herein. In some examples, the lane of the communication channel 108 can refer to any path for transmitting information, such as a transmission line, a copper line, an optical line, a wireless communication channel, an infrared communication link (or channel), or another type of communication path.

In some examples, the CXL protocol uses a physical layer of PCIe to provide high-speed, low-latency connectivity between devices (e.g., CPUs and expansion devices (memory devices, and other types of devices). Examples are presented herein in which the expansion device 106 is an MX device, however, the examples herein should not be construed and/or limited to only MX type of devices. The expansion device 106 can be any type of device that contains at least two (2) tiers of memory and allows for Tier 1 memory to act as a cache of Tier 2 memory (e.g., the Tier 1 memory being DNM 114 and Tier 2 being DFM 112, and through use of a data structure (the PPT 102) which indicates a presence or absence of memory pages cached in the Tier 1 memory).

Because the host device 104 and the expansion device 106 communicate using the CXL protocol, the expansion device 106 can support CXL and in some instances can be referred to as a CXL device. In some examples, the expansion device 106 is implemented as a Type 2 or a Type 3 device (or as a CXL Type 2 or CXL Type 3 device). Example Type 2 devices can include, but are not limited to, a graphical processing unit (GPU), an Application Specific Integrated Circuit (ASIC), a Field Programmable Gate Array (FPGA), an MX device (e.g., an HPG MX device), etc. Example Type 3 devices can include, but not limited to, a memory device, a memory expansion (MX) device, a memory module, etc. Type 3 devices can be used to provide memory capacity expansion and thus expand a memory capacity of the host device 104. Thus, Type 3 devices can be referred to as MXs for host memory. Type 2 and 3 memory devices allow the host device 104 to access CXL device memory cache coherently. Thus, CXL Type 2 and 3 devices, such as the expansion device 106, can have a device physical address space that can be made visible and accessible to the host device 104 through CXL (e.g., the device physical address space is mapped into a host physical address space). In some examples, the expansion device 106 is a coherent memory expansion device, for example, as disclosed in U.S. Pat. No. 11,500,797, which is incorporated herein by reference in its entirety.

The expansion device 106 can include a caching memory (CMC) controller 110. The CMC controller 110 can be implemented as hardware, software (e.g., as machine readable instructions that can be executed on the expansion device 106, such as a by a central processor, controller, etc.), or as a combination thereof. The CMC controller 110 can be used for implementing one or more parts (e.g., actions, steps, etc.) of HPG, as disclosed herein. As shown in FIG. 1, the expansion device 106 includes the DFM 112 and DNM 114. The DFM 112 can correspond to Tier 2 memory and the DNM 114 can correspond to Tier 1 memory. The Tier 1 memory can function as a DFM page cache, and can have attributes of being low-latency and high-bandwidth relative to the Tier 2 memory, which has an attribute of being low-cost relative to the Tier 1 memory. Thus, memory of the expansion device 106 can be organized into a memory hierarchy, where Tier 1 memory is used as a cache for Tier 2 memory. As such, the expansion device 106 can include a number of memory tiers. Example Tier 1 memory can include, but is not limited to, random access memory, such as dynamic random-access memory (DRAM). Example Tier 2 memory can include, but is not limited to, flash memory, such as NAND memory. The CMC controller 110 can store the PPT 102 in the Tier 1 memory, that is, in the DNM 114. While in some examples the PPT 102 can be stored in the Tier 1 memory, in other examples, the PPT 102 can be stored in SRAM. In some examples, the PPT 102 can be constructed on-demand from information contained in the device virtual address (DVA) table (e.g., a DVA 130, as shown in FIG. 1). The information can be contained in a CAM-like structure, where a content addressable memory (CAM) input is the DVA, and the CAM output is an associated DPA (or miss indication if there is no DPA associated with the DVA). The term “on-demand” as used herein refers to an expansion device (e.g., a CMC of the expansion device) constructing or generating a PPT in response to receiving one or more requests from the host device to observe one or more portions of the PPT. The expansion device can return or provide the PPT to the host device once constructed. The system 100 can coherently communicate DNM 114 content and page miss evolvement (DNM miss) through a shared PPT 102, for example, by using coherency semantics defined by CXL for HDM.

For example, using HPG, the host device 104 can request data stored at the expansion device 106. For example, the application 116 (e.g., a word processing application, a game, a cryptographic algorithm, a machine learning algorithm, etc.) executing on the host device 104 can require data (e.g., font data, or other type(s) of data) that is stored at the expansion device 106. The requested data can be provided to the host device 104 for the application 116 through use of the PPT 102 (or some portion thereof). In some examples, a portion of the PPT 102 can reside at the host device 104 and can be referred to herein as the PPE 118. In some examples, the portion of the PPT 102 can correspond to one or more cache line (CL) entries of the PPT 102, as disclosed herein. For example, the PPE 118 can be loaded into (or stored) in a host cache memory 120 of the host device 104. In some examples, the PPE 118 can identify one or more memory pages of DFM 112 that are frequently accessed, have been frequently accessed, or are to be frequently accessed by the application 116. In some examples, the host cache memory 120 is a Level 1 (L1) cache, Level 2 (L2) cache, a Level 3 (L3) cache, and/or a different cache. Thus, in some examples, the host cache memory 120 can include a number of host caches, which can be organized according to a host cache hierarchy.

In some examples in which the PPE 118 is stored in the host cache memory 120, the host cache memory 120 (or some portion thereof) can be referred to as a PPT cache. In some examples, the host cache memory 120 is a host hardware (H/W) coherent cache and can be used to hold some entries from the PPT 102 corresponding to the PPE 118. In some examples, the host cache memory 120 is a specialized type of cache buffer used for memory related operations, such as one or more memory operations as disclosed herein. For example, the host cache memory 120 can be implemented as a lookaside buffer (e.g., a Translation Lookaside Buffer (TLB)), and can be used to store the PPE 118. The lookaside buffer can be used to hold the PPE 118 and when a (DFM) page for the application 116 is needed, the lookaside buffer can be checked by the host device 104 to determine whether the DFM page is present or not present in the DNM 114.

In some examples, the host device 104 can receive device information from the expansion device 106 (e.g., during initialization) and map a physical address space of the expansion device 106 (a device physical memory address (DPA) space) into a physical address space of the host device 104 (a HPA space). The HPA space includes physical memory addresses that are available to the host device 104, such as host memory 122, and/or DFM 112. Thus, the HPA space can include a memory capacity (or memory space) of the DFM 112.

### Applications in HVA Space+Host Maps HVA to HPA

In some examples, the host device 104 can assign the application 116 one or more virtual memory address ranges that it can use (e.g., for storing and managing its data and code, etc.) from the HVA space of the host device 104. The HVA space can include virtual memory addresses that the OS 132 and its processes (e.g., instantiations of one or more programs or applications, such as the application 116) can use. The HVA space of the host device 104 can be organized into units called virtual pages. These virtual pages can be fixed-size blocks. Virtual pages can be mapped into the HVA space, but in some instances, a mapping may not be direct or contiguous. One or more virtual pages allocated/assigned or that can be used by the application 116 in the HVA space can be referred to as host virtual pages. In some examples, the size of a host virtual page can match a size of a memory page of DFM 112. For example, the host device 104 can create the HVA space, which includes host virtual pages. The host device 104 can map the HVA space into the HPA space using a linear address translation, as disclosed herein.

The HPA space can identify physical memory addresses of the DFM 112 that are available to the host device 104 for use (e.g., by the application 116). In some examples, the host device 104 can map the DFM 112 into a system coherent address space (host-managed device memory (HDM)). Because the host device 104 has access to the DPA space of the expansion device 106 via an HPA-to-DPA mapping, the host device 104 can manage the DFM 112 through use of the PPT 102 and thus the DFM 112 can be referred to as host-managed device memory (HDM).

In some examples, the HPA space is a coherent HPA space (HDM). HDM can be a shared memory space where multiple devices (e.g., CPUs, GPUs, or memory expansion devices) can access and manipulate data while maintaining coherence. The term “coherent” means or implies that modifications to data in this shared memory space are visible to all participating devices. This means, if one device updates a memory location, that update is instantly reflected across all devices that have access to that memory. The maintenance of coherency in the HDM (or the coherent HPA space) can be managed by a hardware-level protocol, such as CXL. CXL can be used to handle the communication and synchronization required to keep a shared memory coherent for the system 100, in some examples.

In some examples, referred to herein as a first example, the host device 104 and the expansion device 106 can share a pool of memory (e.g., the host cache memory 120, the DNM 114 and/or the DFM 112). In the first example, the PPT 102 can be cached at the host device 104, such as the host cache memory 120. In other examples, which can be referred to as a second example, a portion of the PPT 102 (that is the PPE 118) can be cached at the host device 104. In either of the first and second examples, the host device 104 and the expansion device 106 can coherently share the PPT (or portions, e.g., the PPE 118) according to a CXL protocol.

In the first example, the PPT 102 can be updated (e.g., changed, modified, etc.) by the expansion device 106 (e.g., by the CMC controller 110). For example, a value (or set of values) can be stored at a particular memory location (or memory locations), which can be referred to as a memory location “M” in the PPT 102. That value (or set of values) can be stored at a particular memory location (or memory locations) such as a PPE 118 (or PPE's) in the host cache memory 120, which can be referred to as memory location “N”. In an initial state, both the host device 104 and the expansion device 106 can have a similar value at respective memory locations “M” and “N”.

In some examples, the expansion device 106 updates the value stored at the memory location “M” corresponding to updating the PPT 102. The CXL protocol (e.g., CXL coherency mechanism of the CXL protocol) enables the host device 104 to detect this update and causes the host device 104 to either invalidate or to update the value stored at the memory location “N”. For example, using the CXL protocol, the host device 104 can invalidate a CL in the host cache memory 120 corresponding to the memory location “N”. The host device 104 can be notified that its cache copy of the PPE 118 is outdated and instructed to invalidate its copy or fetch a new or updated copy of the corresponding entry in the PPT 102 from the expansion device 106. In some examples, the CXL protocol can be used to directly update the host cache memory 120 with the updated PPT 102 entries. The expansion device 106 (e.g., the CMC controller 110) can handle PPT coherency using CXL Type 2 or 3 coherency semantics.

As shown in FIG. 1, the host device 104 communicates with the host memory 122, through use of a system (memory) bus 124. The host memory 122 can be part of the HPA space in some instances. HPA space that is not part of a CXL MX device (or card) (e.g., the expansion device 106) can not be part of HPG mode. Thus, in some examples, for a non-tiered memory, a VMMU (e.g., the VMMU 212, as shown in FIG. 1) can implement a linear translation from HVA to HPA as there is no PPT to be observed for non-tiered memory ranges. The host memory 122 can be implemented as RAM (or DRAM). In some examples, the host memory 122 can be implemented as a memory module (e.g., a board). By way of example, the host memory 122 can be implemented as a dual in-line memory module (DIMM). In additional or alternative examples, the host memory 122 can be implemented as a double data rate type (DDR) device. Thus, in some examples, the host memory 122 can be implemented as a double data rate 3 (DDR3) device, a double data rate 4 (DDR4) device, a Wide I/O 2 (WIO2) device, a high bandwidth memory (HBM) dynamic random-access memory (DRAM) device, an HBM 2 DRAM (HBM2 DRAM) device, an HBM 3 DRAM (HBM3 DRAM), or a double data rate 5 (DDR5) device to name a few.

The host device 104 can also communicate with a storage device 126, as shown in FIG. 1 using a storage interface 128. In some examples, program instructions (for executing the application 116) can be retrieved from the storage device 126 and loaded into the host memory 122 by the host device 104. The host device 104 can fetch and execute the program instructions (e.g., sequentially, in some instances). For example, when a user launches the application 116, the OS of the host device 104 can initiate a loading process. The loading process can cause the host device 104 to locate an executable file of the application 116 on the storage device 126 and prepare it for execution. For example, the storage device 126 can be implemented as a Serial Advanced Technology Attachment (SATA) drive and/or non-volatile memory express (NVMe) solid state drive (SSD).

The expansion device 106 can generate the PPT 102. For example, the expansion device 106 can observe access patterns to DFM 112 by the host device 104 to determine which of the memory pages of DFM 112 to place in DNM 114. By observing a host activity to DFM 112 by the host device 104, the CMC 110 can construct a table with a page present identifier (or bit) for each memory page of DFM 112, and each identifier bit can be stored at the PPT 102. The PPT 102 can be a bit-mapped flat array of “page presence bits”. For example, the PPT 102 can include presence and non-presence identifiers (bits for each page of the DFM 112 to indicate whether a page of DFM 112 is present or not present in the DNM 114 (e.g., DRAM). For each page of DFM 112, the PPT 102 can indicate with a bit whether that page is present or absent in the DNM 114. Because each bit of the PPT 102 indicates a presence or absence of a page of DFM 112 in the DNM 114, these bits can be referred to as page presence bits. For example, the CMC 110 does not require that the PPT 102 be a physical storage array. Portions of the PPT 102 can be constructed on-demand in response to the host device 104 access requests of PPE 118 entries. These PPE 118 entries can be transient at the CMC 110, constructed and existing temporarily within the CMC 110 to satisfy a data phase of a host device PPE read request. Thus, the CMC 110 in some instances does not need to observe the PPT 102, and can construct a fragment (e.g., a cache line (CL), which can contain 64 bytes (64B) of data, wherein each byte can consist of 8 bits; 512 bits (512b) in total for the cache line).

For example, if the host device 104 receives a memory request from the application 116 containing an HVA, the VMMU can convert the HVA to HPA. The VMMU can check the PPT 102 to determine if a page related to the HPA is in the DNM 114. If the host device 104 has not cached the needed PPT entry (e.g., the PPE 118), the host device 104 can issue a memory request to fetch 1 CL of the PPT 102. The CMC 110 can receive the memory request (e.g., memory read request) for a CL of the PPT 102, and constructs that CL of the PPT 102 (e.g., 512 PPT bits, of which 1 of those bits is the one related to an application memory request's page) on-the-fly. If the page related to the HPA is in the DNM 114, the host device 104 communicates (forwards) the memory request to expansion device 106. If the page related to the HPA is not in the DNM 114, the host device 104 informs the expansion device 106 that the page should be placed in the DNM 114 (e.g., by using host-side signaling). The expansion device 106 fetches the page, and places the page in the DNM 106, updates a DVA table entry (with the new HPA to DPA association) and invalidates a host PPT (which will cause the host device 104 to re-acquire an entry in the subsequent check by the VMMU). The expansion device 106 can notify the host device 104 that, for example, the host-side signaling has been resolved. The VMMU can re-acquire and check the PPT 102, and will find that page is now present, and the host device 106 can forward the original application's memory request to the expansion device 106.

For example, when a presence bit of the PPT 102 is zero (0), the corresponding page of the DFM 112 is not present in the DNM 114 and when a presence bit is one (1), the corresponding page of DFM 112 is present in the DNM 114. In some examples, the CMC controller 110 maintains a host accessible PPT, such as the PPT 102, and supports a communication mechanism (e.g., a software (S/W)-compatible page-fault messaging protocol) to process host page faults exceptions. Thus, the CMC controller 110 can support device side paging (DSP) through managing the PPT 102 and the S/W-compatible page-fault messaging protocol. For example, the host device 104 can manage access to data in the DNM 112 based on the PPT 102.

### Application HVA→HPA→DFM

In some examples, the application 116 reads from or writes to a virtual memory location identified by an HVA in its allocated virtual memory address space which can be translated (e.g., by the host device 104, as disclosed herein) to a physical memory address in the HPA space. The HPA can identify a location of a page of the DFM 114 for the application 116.

### PPE: Present/Not Present

In some examples, where the HPA is associated to a 2-tier expansion device 106, the host device 104 checks the PPE 118 to determine whether the HPA is present in the DNM 114 (e.g., in examples in which a copy of the PPT is cached (or stored) at the host device 104).

### Present==DFM Mapped to DNM+DRAM Hit

In some examples, if a page of the DFM 112, associated with an HPA of a memory request, is marked as present in the PPE 118 (that is, has a presence bit of one (1)), then the page of DFM 112 is in (or loaded into) the DNM 114. A memory request targeting a present page is called a hit (e.g., a DRAM hit). The host device 104 can provide a memory request (e.g., a lower-level memory request) (or data request) for the data stored at the DFM 112, to the expansion device 106, and if this memory request is a hit, the expansion device 106 can complete the memory request with data accessed from the DNM 114.

Accordingly, if an HPA corresponding to a PPT 102 entry (the PPE 118) is marked as present, this is an indication that the page is loaded into (or located in) the DNM 114. The CMC controller 110 can implement memory address translation to derive the DPA (derived or determined based on a device virtual memory address (DVA) table 130 and the HPA) to identify a page in a device physical memory (the DNM 114) of the expansion device 106. Using the HPA of a host memory request, a DPA can be identified by the CMC controller 110 and data at a DNM 114 location can be provided from the expansion device 106 to the host device 104 in response to the host memory request.

### DVA Maps HPA to DPA+Device Maintains DVA

In some examples, the CMC controller 110 can compare the HPA to the DVA table 130. The DVA table 130 may not be visible to the host device 104. The DVA table 130 can be used by the CMC 110 in a virtual address translation stage between HPA and DPA. The DVA table 130 can provide a mapping between the DFM 112 (which is in HPA space) and the DNM 114 (which is in DPA space) for the expansion device 106. Thus, from the host device 104 perspective, memory pages of the DFM 112 that are present (as indicated by a presence bit within the PPT 102) in the DNM 114 can be accessed by host memory requests providing an associated HPA. Through the use of the DVA table 130, the CMC controller 110 can perform device virtual address translation (e.g., from HPA to DPA). The CMC controller 110 can use the DVA table 130 to perform device virtual address translation to map an HPA to a location in DNM 112. Thus, the host device 104 performs no address translation between HPA and DPA, as this is handled by the expansion device 106 in HPG mode, as disclosed herein. The DVA table 130 can be generated and maintained by the CMC controller 110 in response to, or independently from, host device 104 activity.

### Miss Memory Request

In some examples, the host device 104 can issue or generate a memory request to an expansion device 106 whose HPA (in the DFM 112) is not associated to a DPA (in the DNM 114) in the DVA table 130 (e.g., a DRAM miss). This can result in the CMC 110 assigning an available DPA to that HPA, copying the associated page (frame) from the DFM 112 to the DNM 114, updating the DVA table 130 to reflect the assignment, updating the PPT 102 to reflect the presence of the page in the DNM 114, and invalidating an associated PPE 118 (if one exists) by means of the CXL coherency protocol. In some examples, if the host device 104 happens to interrogate the PPT 102, it can determine that the presence bit is “0” (not present), and thus the page is not present. The host device 106 can forward the memory request to the expansion device in examples in which the presence bit for that page is determined to be “0” or not present. Thus, in some examples, the host device 106 can ignore the PPT 102, and the expansion device 106 can handle the miss (DRAM miss) upon arrival of the memory request.

### Expansion Device Makes Predictions

In some examples, the CMC 110 can predict (e.g., using a cache prediction algorithm) that the host device 104 will in the future issue requests for an HPA not currently mapped into the DPA space (e.g., a DFM page not currently cached in the DNM 114). Example cache prediction algorithms can include, but not limited to, temporal, spatial, algorithmic, artificial intelligence (AI), branch, equidistant, etc. For example, the CMC 110 can use spatial and temporal techniques, and in some instances, information from the OS 132, to predict if the host device 104 will in the future issue requests for the HPA not currently mapped into the DPA space. Information from or provided by the OS 132 can include, for example, how the application 116 is initializing its memory space. In some examples, an observer agent can be run to monitor a behavior of the application 116 and construct (or generate) a histogram that can be mined, such as by the CMC 110 (in other examples by the host device 104) for predictive data. The CMC 110 can use the predictive data to make the prediction, as described herein. The CMC 110 can allocate an available page from the DNM 114 for this purpose, copy the associated page from the DFM 112, update the DVA table 130 and the PPT 102 to indicate a presence of the page in the DNM 114, and invalidate any copy that can be present in the PPE 118 by way of the CXL coherency protocol. This can be referred to as a predictive page read.

### Page Fault

In some examples, if the page associated with the HPA of a memory request is not marked as present in the portion of the PPT 102 (the PPE 118) (e.g., has a presence bit of zero (0)), this can provide an indication to the host device 104 that the page associated with the HPA is not loaded or located in the DNM 114. A host device 104 can receive a memory request with an HVA from the application 116. A VMMU (e.g., the VMMU 212, as shown in FIG. 2) can translate an HVA to an HPA. In HPG mode, the translation from HVA to HPA is a linear reversible transform. A linear reversible transform refers to a mathematical operation (transformation) that can be applied to a set of data in a way that is both reversible and linear. Thus, original data can be reconstructed from transformed data using a similar operation in reverse. If the HPA is marked as not present in the PPE 118, the VMMU can issue a page fault exception. Thus, a page fault exception can occur due to the application 116 accessing a part of its virtual memory that is not in the DNM 112.

### Host-Side Demand Page Fault Exception & DRAM Miss

In some examples, the expansion device 106 can receive a page fault exception from the host device 104. For example, if the host device 104 detects a potential miss (e.g., DRAM miss), the host device 104 can send a page fault exception containing the HPA of the memory request (that would otherwise result in a Miss (e.g., DRAM miss)) to the CMC 110. The HPA indicates a frame within the DFM 114 associated with the miss. A page fault exception sent by the host device 104 to the expansion device 106 due to a potential miss is called a host-side demand page fault exception. For example, the application 116 can issue the memory request to an HVA which is not currently in the DNM 114. The VMMU can detect that the HVA is not currently in the DNM 114 and hold back the memory request from being provided to the expansion device 106. In example in which the VMMU or the host device 104 does not issue the memory request to the expansion device 106 in scenarios in which the HVA is not currently in the DNM 114 can be referred to as a potential miss. The VMMU issues a page fault exception based on the detection. After the page fault exception is resolved (and therefore the memory request is now in the DNM 114) the VMMU allows the request to be issued to the expansion device 106. The CMC 110 can resolve a host-side demand page fault exception in a same or similar manner to a DRAM miss. The CMC 110 can assign an available DPA to the HPA (provided by the page fault exception), copy the associated page (frame) from DFM 112 to the DNM 114, update the DVA table 130 to reflect the assignment, update the PPT 102 to reflect the presence of the page in the DNM 114, invalidate an associated PPE (if one exists) by means of the CXL coherency protocol, and then provide a page fault exception completion response to the host device 104. In some examples, the CMC 110 handles a host-side demand page fault exception with higher priority than other paging events, attempting to minimize a page fault completion time (e.g., page fault latency). In some examples, when sending a host-side page fault exception, the host device 104 does not issue the associated memory request to the expansion device 106 until after the expansion device 106 indicates to the host device 104 that the page fault has been resolved. For example, the expansion device 106 can notify the host device 104 when page miss events are resolved (e.g., via a Message Signaled Interrupts Extended (MSI-X), mwake, or similar command or instruction).

### Device-Side Demand Page Fault Exception

By contrast, examples in which the VMMU or the host device 104 issues (forwards) the memory request to the expansion device 106 in scenarios in which the HVA is not currently in the 114 DNM can be referred to as a miss (DRAM miss). In those examples, the application 116 issues the memory request to the HVA which is not currently in the DNM 114. The host device 106 forwards the memory request to the expansion device 106. The expansion device 106 can receive a request whose HPA is not present in the DNM 114.

In some examples, the expansion device 106 detects a Miss (e.g., DRAM miss) directly. For example, the CMC 110 can receive a memory request and search the DVA table 130 for the HPA of the memory request and determine that the memory request has invoked a miss because the associated page of the DFM 112 is not present in the DNM 114. A page fault detected by the expansion device can be referred to as a device-side demand page fault exception, and can be handled by the CMC 110.

### Suspension of Process to Avoid a Miss

In conjunction with issuing a host-side page fault exception, the host device 104 can also suspend or pause a process, which can be an instance of the application 116 (or a portion of the application 116 known as a thread) being executed based on a potential miss (e.g., DRAM miss). When the VMMU detects the potential DRAM miss during an execution of the application 116, the OS 132 can temporarily halt the process while an associated host-side page fault exception is issued and then resolved by the CMC 110, after which the OS 132 can resume the suspended process. The host device 104 can then re-acquire and check an associated present bit of the PPE 118, noting that the page is now marked present, the process can be resumed, the offending memory request can be completed from the DNM 114, avoiding the miss.

### Host Accessing DFM Without Observing PPT

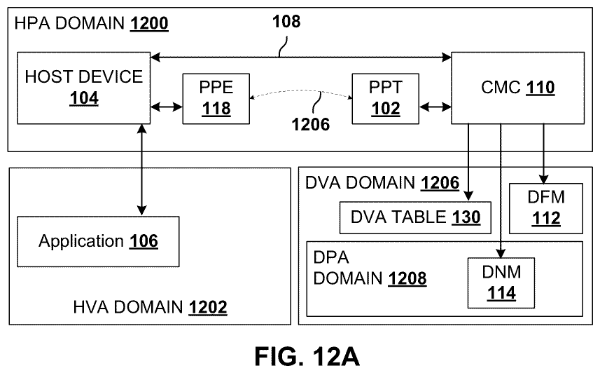

In some examples, the host device 104 does not observe the PPT 102, and does not store a portion of the PPT 102 and thus does not store the PPE 118 in the host cache memory 120. Because the host device 104 does not observe the PPT 102, the host device 104 can be configured to forward all memory requests targeting the DFM 112 to the expansion device 106 without regard for the presence of the page of the DFM 112 in the DNM 114. For example, the host device 104 can, after translating a HVA to an HPA, forward a memory request with the HPA to the expansion device 106. The expansion device 106 can use the DVA table 130 to determine whether the associated page of DFM 112 is present in the DNM 114 in a same or similar manner, as disclosed herein. All of the information that provides mapping from DFM (DVA) to DNM (DPA) can be held in the DVA table 130. The DVA table 130 is used by the expansion device 106 to perform translation from DVA to DPA (e.g., see FIG. 12B). The DVA table 130 can also be used by the expansion device 106 to generate any portion of the PPT 102 (e.g., the PPE 118) being requested by the host device 104.

### Eliminating Multi-level Page Walks

Accordingly, by using HPG mode, page management can be split up (or divided) between the host device 104 and the expansion device 106 through use of the PPT 102. For example, the host device 104 can observe the PPT 112 without modifying the PPT 102 (or the PPE 118 in some examples). The host device 104 can perform host-side address translation from HVA to HPA. The expansion device 106 can perform device-side address translation from HPA to DVA and then from DVA to DPA. By distributing address translation in this manner, the expansion device 106 improves memory access time, reduces address translation latency, and does not require the host device 104 to implement multi-level paging schemes (as existing approaches use) to manage virtual-to-physical address translation for accessing data needed on the expansion device 106 by an application (e.g., the application 116) or program. As disclosed herein, host virtual address translation (from HVA to HPA) can be done by a linear transform, while device address translation (e.g., host physical to device virtual to device physical) can be performed by the expansion device 106. Resultantly, this frees up resources of the host device 104 for other processing.

### Page-Level Attributes Not Needed

Furthermore, through use of HPG, a host device, such as the host device 104 does not use page-level attributes to manage a particular page in memory in terms of caching behavior, access permissions, and memory management strategies. Page-level attributes are specific flags or bits in a page table entry that provide an OS of the host device with information on how to handle a particular virtual page of memory, for example, of an expansion device, such as the expansion device 106. Because HPG mode creates a 1-to-1 mapping of HVA to HPA, this enables the expansion device 106 to handle a particular physical page of memory based on the PPT 102 (rather than through use of one or more page table entries as required by conventional paging protocols), and eliminates the need for a host page table for address translation from HVA to HPA space; thus HPG does not require use of page-level attributes, such as, for example, Page Attribute Table (PAT), Read/Write (R/W), User/Supervisor (U/S), Accessed (A), Dirty (D), and Global (G).

Accordingly, by configuring the system 100 to use HPG, the host device 104 performs no non-linear (e.g., address indirection via page table walks) virtual address translation. Instead, the host device 104 performs linear address translation from HVA to HPA, and then uses HPA as an index into the PPT 102. The host device 104 reads (or observes) the PPT 102 (and thus creates no other paging structures as existing paging protocols create). Thus, the system 100 does not require use of page-level cache typing, page-level R/W control, or page-level access tracking. The expansion device 106 allows for device-side paging through the use of the CMC 110. The CMC 110 can maintain a host-accessible PPT (the PPT 102) and uses a coherent communication mechanism (e.g., a CXL mechanism) to share the PPT with the host device 104. The CMC 110 can perform HPA to DPA translation through a device-side non-linear mapping algorithm which is tracked through the DVA table 130.

FIG. 2 is an example of a block diagram of a computer system 200. The computer system 200 includes a host system 202 and the expansion device 106, as shown in FIG. 1. The host system 202 includes the host device 104, as shown in FIG. 1. Thus, reference can be made to one or more examples of FIG. 1 in the example of FIG. 2. The host device 104 can be a central processing unit (CPU). The computer system 200 can be configured to implement HPG mode, enabling the host device 104 to observe and manage paging of data stored on the expansion device 106 and used by the host device 104.

### PPT Indicates Presence or Non-Presence of Data in DNM

For example, the application 116 executed on the host device 104 can issue a memory request for data stored at the expansion device 106. The host device 104 and/or the expansion device 106 can use the PPT 102 (or a portion thereof, in some instances) to determine whether the data is cached in DNM on the expansion device 106 prior to forwarding the memory request to the expansion device.

The host device 104 and the expansion device 106 can communicate using an interconnect (or a bus) 232 of a printed circuit board (PCB) 204 of the computer system 200, as shown in FIG. 2. The communication channel 108, as shown in FIG. 1, can be implemented over the bus 232. For example, the expansion device 106 can include a connector (e.g., having edge connections) that can interface (e.g., can be inserted into) with an expansion slot of the PCB 204 to provide an electrical connection or pathway between the host device 104 and the expansion device 106 corresponding to the bus 232.

The host device 104 can include a number of cores, of which a single core of the host device 104 is shown in the example of FIG. 2 for clarity and brevity purposes. The host device 104 can be used to execute software and/or modules, and/or other system software. For clarity and brevity purposes not all components of the host device 104 are shown in the example of FIG. 2. The host device 104 can include one or more execution units 206 (referred to herein as an execution unit). The execution unit 206 can include components for implementing instructions and performing calculations for implementing one or more functions, actions, and/or operations, as described herein. The components can vary in number and type depending on CPU architecture, but generally include logic units (arithmetic logic units (ALUs), floating-point units (FPUs), and in some instances other specialized hardware for specific tasks.

For example, upon initiation (e.g., power up), the computer system 200 can enter a boot-up phase and the host device 104 starts operating in a boot mode. During the boot-up phase, the host device 104 can start executing instructions from a predefined memory containing Basic Input/Output System (BIOS) code. During BIOS initialization, the BIOS can perform a power-on self-test (POST) to check or verify a functionality of hardware components, including a CPU, RAM, storage devices, and input/out interfaces (e.g., keyboard, mouse, etc.) and the expansion device 106. If the POST is successful, the BIOS can proceed to initialize system hardware, including setting up the host device 104 and configuring the memory (e.g., the host memory 122). After hardware initiation by the BIOS, the BIOS can identify and select a boot device from which the operating system (OS) 132 is loaded. Common boot devices can include, for example, the storage device 126, as shown in FIG. 1. The BIOS can locate a bootloader on the storage device 126. For example, the BIOS can locate a master boot record (MBR) or an EFI System Partition (ESP) on the storage device 126. The BIOS can load the bootloader (e.g., code) from the MBR or ESP into the memory (e.g., the host memory 122, as shown in FIG. 1). The bootloader is a program responsible for imitating loading of the OS 132, as shown in FIG. 1. In some examples, before loading the OS 132, the bootloader switches the host device 104 from boot mode to protected mode (also known as protected virtual address mode, in some instances).

In some examples, the bootloader is programmed to locate and load a kernel 210 of the OS 132. The bootloader, for example, can read a kernel's location from configuration files or specific addresses on the storage device 126 (the boot device). Once the bootloader locates the kernel 210, a kernel's executable image (e.g., machine code) is loaded into the host memory 122. The kernel 210 can take over from the bootloader for system operation initialization. For example, during the boot-up phase, the kernel 210 can take control (e.g., from the bootloader or the BIOS). The transition from the bootloader to the kernel 210 involves the kernel 210 taking control of the system's execution. During initialization, the kernel 210 can unitize system resources, configure hardware, and set up essential data structures. The kernel 210 can recognize a presence of the expansion device 106 and initialize the expansion device 106. The kernel 210 can include one or more device drivers for various components, including the expansion device 106. These drivers are responsible for detecting and initializing hardware components, such as the expansion device 106. The drivers can configure settings and make the hardware components available for use by the OS 132 and applications, such as the application 116, as shown in FIGS. 1-2. Once the kernel 210 has control, the kernel 210 can implement virtual memory management to establish or define an initial memory management environment for the computer system 200. The initial memory management environment created by the kernel 210 sets a stage for subsequent memory-related operations in the computer system 200. It ensures efficient utilization of physical memory resources, memory protection, and the ability to isolate processes from one another. As processes and/or applications run, the processes and/or applications operate within this framework, benefiting from virtual memory, memory protection, and efficient memory allocation provided by the kernel 210.

For example, the kernel 210 can setup or configure the host device 104 for virtual memory or virtual memory management, such as HPG. For example, the kernel 210 can pool various memory and/or storage resources in the computer system 200 together and present them as a virtual memory space. For example, the kernel 210 can generate a memory map, which can be software defined. The memory map can be accessible by the application 116. The memory map can map a HVA space into a HPA space. For example, the kernel 210 can implement mapping of the DFM 112 space of the expansion device 106 into the HPA space, as described herein. The HPA space can include a memory capacity of the expansion device 106 and the host cache memory 122. This allows the host device 104 to manage the host cache memory 122 and memory of the expansion device 106 (e.g., host-managed device memory or HDM, as defined in the CXL specification), such as the DFM 112, as shown in FIGS. 1-2, in a coherent and integrated manner, ensuring that memory access, data consistency, and performance are optimally maintained.

The kernel 210 can be used to implement a virtual memory management process through use of the host device 104. For example, the kernel 210 can configure the host device 104 for HPG. For example, the host system 202 can include a VMMU 212. The VMMU 212 can be configured (e.g., setup) by the kernel 210 of the host device 104 for HPG. The configuration code can be implemented as machine readable instructions to configure the host device 104 and VMMU 212 for HPG. Thus, the VMMU 212 can enable the host device 104 to use HPG mode (or use an HPG feature of the virtual memory management process, as disclosed herein).

For example, configuration code instructions issued by the kernel 210 can be executed by the execution unit 206 to setup (or initialize) hardware of the host device 104, such as system registers 218 for HPG. Configuration code can instruct the host device 104 to set system bits of the system registers 218 to control operations of the host device 104 and the VMMU 212 for HPG. The system bits can be used to enable/disable features and/or an operation mode of the host system 202.

To configure the host system 202 for HPG, configuration code can program (or set bits of) the system registers 218 of the host device 104. In some examples, the system registers 218 can include control registers. For example, configuration code, upon execution by the host device 104, can be used to setup the system registers 218 to configure the host device 104 and VMMU 212 to use the HPG mode. For example, configuration code can cause the host device 104 (e.g., a control unit of the host device 104) to modify a state of one or more host system bits of the system registers 218 to enable the host device 104 and VMMU 212 to operate in the HPG mode. In HPG mode, the kernel 210 can manage data stored on the expansion device 106, as disclosed herein. The one or more host system bits can include enable bits (e.g., for configuring the host system 202 to use the HPG mode), configuration bits (e.g., for defining operational parameters of the HPG mode), and table bits (e.g., for configuring or setting parameters for defining or generating the PPT 102, as shown in FIGS. 1-2). In some examples, the host device 104 can be implemented based on the x86 architecture, and the system registers 218 can include (among other registers) a CR0 register 220, a CR3 register 222, a CR4 register 224, and a CR5 register 226, which can include bits corresponding to one of the enable, configuration, and table bits (the host system bits). The configuration of the host system bits of the system registers 218 can enable the HPG mode of the host system 202 and thus configure the host system 202 to operate according to a HPG protocol for accessing data from the expansion device 106 based on the PPT 102.

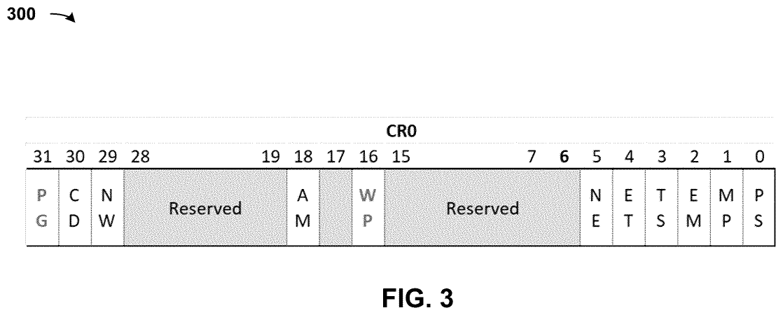

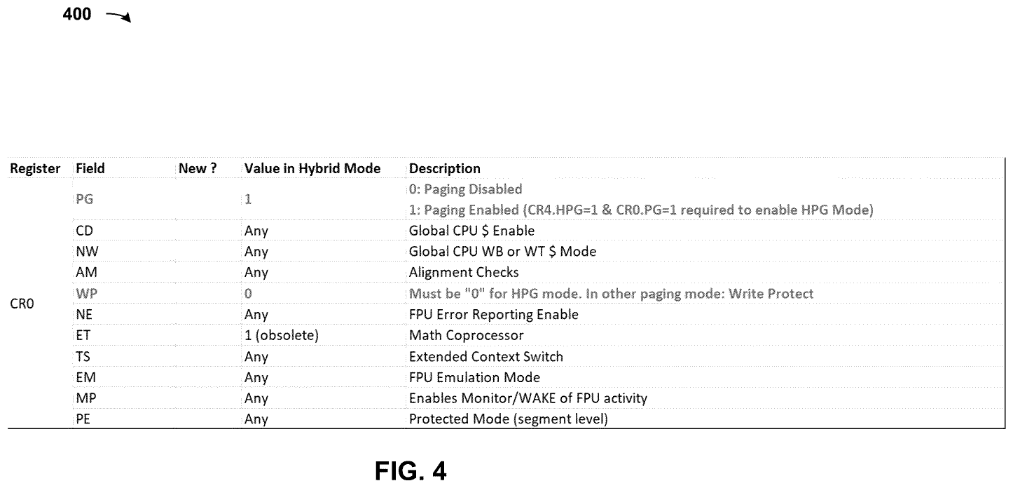

For example, the configuration code can instruct the host device 104 to set a page (PG) bit (the enable bit) in the CR0 register 220. This PG bit, when switched from 0 to 1, enables paging on the host system 202. FIG. 3 is an example of a CR0 register bit map table 300. In the table 300, the PG bit is bit 31. The configuration code can instruct the host system 202 to set bit 31 to “1” to enable paging on the host system 202. The configuration code can cause a write protect (WP) bit (a configuration bit) of the CR0 register 220 to be set to “0” to configure the HPG mode of the host system 202. In other paging modes (e.g., non-HPG modes), the WP bit can be set to “1”. The host device 104 does not use a page-level protection mechanism in the HPG mode as no page-level hierarchy is implemented at the host system 202 for paging when the WB bit is set to “1”. FIG. 4 is an example of a CR0 register bit description table 400.

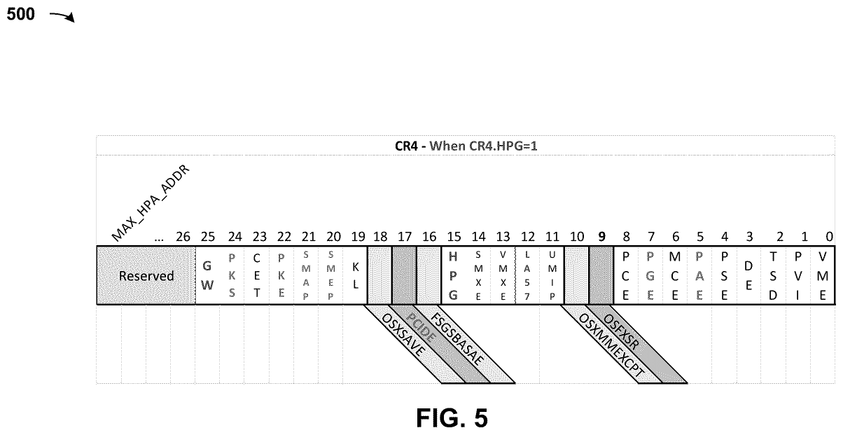

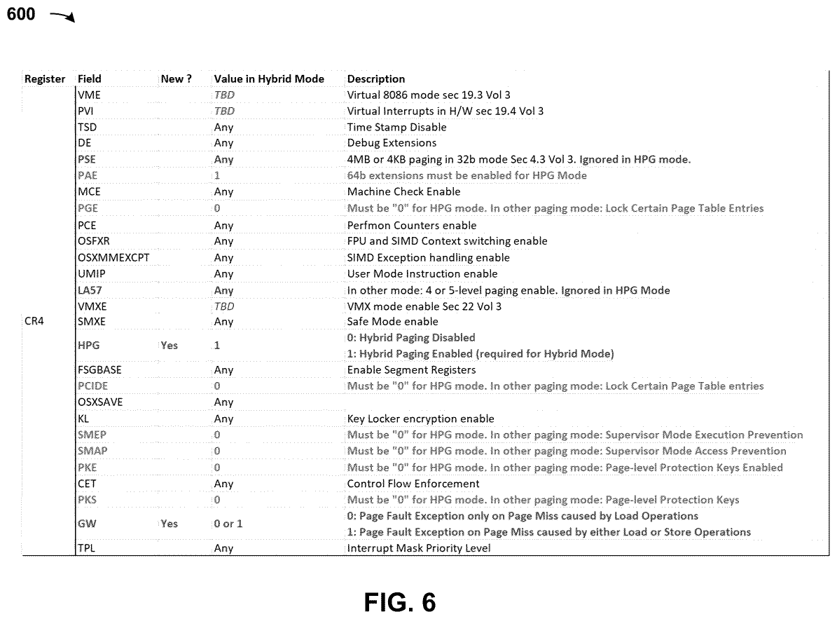

FIG. 5 is an example of a CR4 register bit map table 500, and FIG. 6 is an example of a CR4 register bit description table for the CR4 register bit map table 500. In some examples, the configuration code can instruct the host device 104 to set a HPG bit in the CR4 register 500, as shown in FIG. 5. This HPG bit, when switched from 0 to 1, enables HPG mode (or allows the host system 202 to use HPG). For example, the configuration code can instruct the host device 104 to set the HPG bit to “1” to enable hybrid paging. By setting the PG bit and the HPG bit to “1” configures the host system 202 to use the HPG mode. The configuration code can instruct the host device 104 to set other bits of the CR4 register 500 as well to configure the HPG mode of the host system 202. For example, the configuration code can instruct the host system 202 to set a process-context identifier enable (PCIDE) bit, a supervisor mode execution protection (SMEP) bit, a supervisor mode access prevention (SMPA) bit, a protection key supervisor (PKE) bit, and a protection key enable (PKE) bit of the CR4 register 224 to “0” for the HPG mode. The PCIDE bit is set to “0” for the HPG mode as the HPG mode does not use page table entries and thus locking of page table entries is not needed or required in the HPG mode. The SMEP bit is set to “0” for the HPG mode to disable supervisor mode execution prevention. The SMAP bit is set to “0” for the HPG mode to disable supervisor mode access prevention. The PKE bit and the PKS bit is set to “0” to disable page-level protection keys as the HPG mode does not use page-level protection.

In some examples, the configuration code can instruct the host device 104 to set a physical address extension (PAE) bit and a page global enable (PGE) bit of the CR4 register 224. The PAE bit is a control feature, for example, for an x86 CPU architecture. The PAE bit can be used to enable or disable a PAE mode, which allows the host device 104 to access more physical memory (e.g., more than 4 GB) on a 32-bit system. The PAE bit can be used to extend a physical address space from 32 bits to 36 bits, which allows the host device 104 to address a greater amount of physical memory (e.g., up to 64 GB of physical memory instead of a 4 GB limit of standard 32-bit addressing). The PAE bit is set to “1” to enable the host device 104 to map the physical memory of the expansion device 106 into a physical memory space of the host device 104.

The configuration code can instruct the host device 104 to set a GW bit of the CR4 register 224, which is a host page fault mask bit. The GW bit can be used to control based on which operation a host page fault (page fault exception) is generated or issued by the host device 104. For example, when the GW bit is set to “0” the host device 104 generates or asserts a page fault exception only when a page miss is caused by a load operation. By contrast, when the GW bit is set to “1” the host device 104 provides the page fault exception when a page miss is caused by either a load or a store operation. As shown in the table 600, the HPG and GW bits are “new” bits as these bits are not used in a conventional paging mode of the host device 104 (e.g., a non-HPG mode). A “new bit” as used herein and/or referred to in the accompanying drawings refers to a system register bit (or control register bit) that is not used in conventional paging techniques. Thus, a new bit can be used for HPG.

In some examples, the configuration code can instruct the host device 104 to configure one or more system bits of the CR3 register 222. For example, configuration code can instruct the host device 104 to set DFM Page granularity (MG) bits and PPT base address (PPTBASE) bits of CR3, for example, when the HPG bit of the CR4 register 224 has been set to “1”. The PPTBASE bits can identify the HPA of the starting memory location of the PPT 102. The CR3 register 222 can store (hold) a starting memory address of the PPT 102 in the HPA space.

The MG bits of the CR3 register 222 can specify the page granularity of the DFM 112. Page granularity refers to a size of individual memory pages 234 of DFM 112 that can be used for address translation and/or memory allocation. MG bits can be used to define a size of each page in HPA space of the expansion device 106. In a virtual memory domain, page granularity defines the size of individual memory pages in a HVA space used for address translation and page fault handling by the host device 104. Each virtual address (HVA) generated by a process corresponds to a specific page in virtual memory, and the size of that page can be determined by the chosen page granularity. By contrast, in a physical memory space, page granularity determines the size of physical memory pages 234 of the DFM 112. Physical memory is organized into fixed-size pages, and these pages are used for allocation, data storage, and other memory management operations. The size of a physical memory page 234 can be configured to match the size of a virtual memory page.

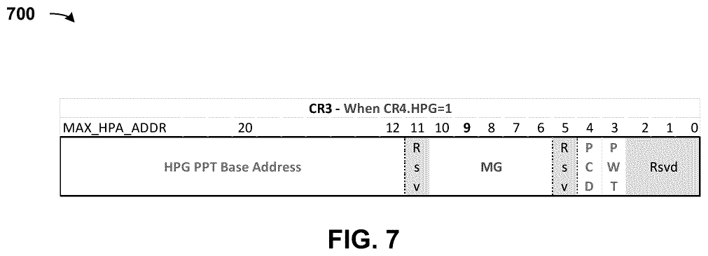

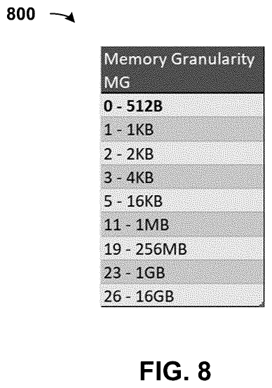

In some examples, the configuration code can instruct the host device 104 to set a page-level cache disable (PCD) and page-level write-through (PWT) bits for specifying a memory type that is used to access the PPT 102. In the HPG mode, the PCD and PWT bits are used for a different purpose than other existing paging modes. FIG. 7 is an example of a CR3 register bit map, table 700. In table 700, the PWT bit is bit 3, the PCD bit is bit 4, the MG bits are bits 6-10, the PPTBASE bits are bits 12-20 of the CR3 register 222. FIG. 8 is an example of a memory granularity (MG) table 800. The MG bits can be used to define the page size (e.g. granularity) of the DFM 112 represented by each bit in the PPT 102, for example, according to the table 800.

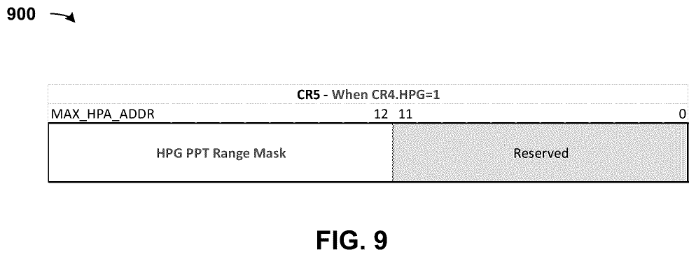

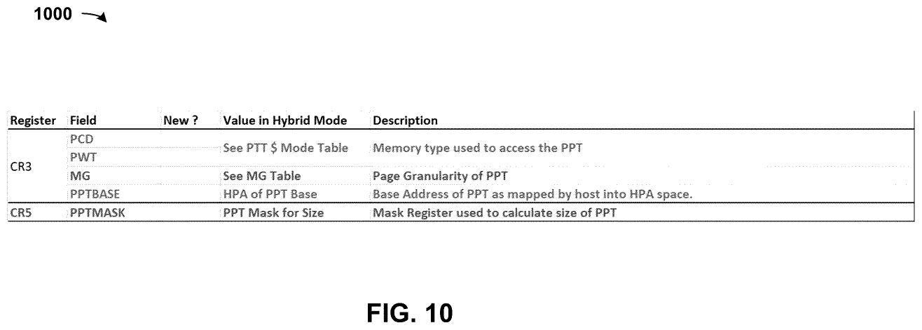

In some examples, the configuration code can instruct the host device 104 to set PPT mask register (PPTMASK) bits (identified as “HPG PPT Range Mask” in FIG. 9) of the CR5 register 226. The PPTMASK bits can be used to specify the size of the PPT 102. For example, configuration code can instruct the host device 104 to compute the size of the PPT 102 based on a memory capacity of the DFM 112 and DFM page granularity and store the computed result (e.g., bits) as the PPTMASK bits in the CR5 register 226. By way of non-limiting example, the size of the PPT 102 can be determined by dividing the size of the DFM in bytes/32768. For the host device 104, since there can be multiple expansion devices, CR5 can be programmed with a sum total of all expansion devices PPT sizes. The DFM page granularity can be determined based on the MG bits of the CR3 register 222. The memory capacity of the DFM 112 is at least a sum of size of all enabled DFM CXL decoders of the expansion device 106. FIG. 9 is an example CR5 register bit map table 900. In the table 900, the PPTMASK bits are bits 12-31. FIG. 10 is an example of CR3 and CR5 register bit description tables. Accordingly, the configuration code can instruct the host device 104 to configure (or set) system registers 218 to configure HPG mode for the host device 104. The host device 104 once configured can access data stored on the expansion device 106 as well as information stored in the PPT 102.

In some examples, the host device 104 can include memory type range registers (MTRR) 228. The MTRR 228 can be used to control how different regions of memory are cached and thus can define a caching behavior (e.g., whether a region of memory is to be cached, and if so, what type of caching strategy should be used (e.g., write-through (WT), write-back (WB), write-protect (WP), uncatchable (UC), etc.)). Configuration code can enable the host device 104 to cache DFM as well as the PPT (e.g., the PPE 118 and/or the PPT 102) using the MTRR 228. For example, configuration code can instruct the host device 104 to cache the DFM 112 in a same or similar manner as it would with a standard (homogenous DRAM) CXL Type 3 MX device. In some examples, the host device 104 can cache the PPT 102 using the MTRR 228. For example, referred to herein as a given example, a respective MTRR of the MTRR 228 can cover a range that defines a different User Level and System Level cache promotion scheme. In the given example, the configuration code can instruct the host device 104 to configure the respective MTRR for a particular (or desired) caching strategy. The configuration code can instruct the host device 104 to set the PCD and the PWT bits to limit a highest level of cache promotion allowed for User Level.

In some examples, the HPG mode does not support paging attributes via the PAT. PAT provides a caching strategy (Cache Mode) based on virtual addressing, where virtual (HVA) to physical (HPA) translation can change with time. In HPG mode, the virtual to physical translation does not change with time. This is because the PPT 102 does not contain page-directory or page-table entries.

In some examples, the configuration code can instruct the host device 104 to associate a physical memory range for the PPT 102 with the WP (write protect) memory type. For example, the host device 104 can create and assign a data segment to the physical memory range for the PPT 102. This segment descriptor can be used to protect the PPT 102 from kernel and user level host writes. The host device 104 can access the PPT 102 through this R-O logical address range. The segment descriptor can hold information about a particular virtual memory segment and access rights to that virtual memory segment (e.g., reading, writing, executing permission, etc.) A segment selector associated with that segment can be used for accessing data or code in that specific segment. The segment selector can be an index or reference to a segment descriptor in a descriptor table. Read-Only attributes can be assigned to the virtual memory segment mapped to the physical segment that holds the PPT 102 and access of the PPT 102 by the host device 104 can be restricted to read operations (or requests).

As disclosed herein, address translation is implemented at the expansion device 106 and thus the host device 104 does not need to use a translation lookaside buffer (TLB) (special purpose cache) of a VMMU of a host device. Thus, as disclosed herein, the host device 104 can cache the PPT 102 in the host cache memory 120 according to the MTRR 228, which can be configured by the configuration code. The HPG protocol supports MTRR as a method used to assign a memory type (caching strategy) to the DFM 112 and the PPT 102 physical memory ranges of the expansion device 106.

In some examples, the CXL protocol (e.g., a coherency mechanism of the CXL protocol) can be used to maintain PPT coherency, that is, maintain coherency between a copy of the PPT 102 stored on the host device 104 and the PPT 102 on the expansion device 106. Thus, PPT coherency can be maintained at an H/W layer in the computer system 200. As such, there is no requirement or need for S/W coherence in a system using HPG for accessing the PPT 102 data from the expansion device 106. The use of S/W coherence techniques (e.g., a page structure S/W invalidation and TLB shoot down, for example) in management of paging structures and TLB's results in significant latency and jitter, and can also be prone to complex S/W consistency issues.

In some examples, to invalidate a portion of the PPT 102 (e.g., the PPE 118) stored at the host device 104, which can in some instances be referred to as a host PPE (by contrast the PPT 102 stored at the expansion device 106, which can be referred to as a device PPT) when it is outdated, the expansion device 106 can issue a command (or instruction). The type of command (or instruction) used will be based on a type of CXL device. In some examples, in which the expansion device 106 is a CXL Type 3 MX device a back-invalidate (BINVD) instruction can be generated or issued to invalidate cache entries (or memory locations) in the host cache memory 120 at which the PPE 118 is stored. The BINVD instruction results in clearing the host device's caches at which the portion of the PPT 102 is stored by marking the PPE 118 therein as invalid. This forces the host device 104 to fetch or retrieve the PPT 102 entry from the expansion device 106 (from memory), and update the PPE 118 cache entry if the Host Device 104 is to observe the entry after invalidation has occurred.

Accordingly, in some examples, the expansion device 106 (e.g., the CMC 110) can use CXL H/W coherence to invalidate PPT entries. In some examples, a Type 3 CMC device (e.g., a CXL Type 3 device with the CMC 110, as shown in FIG. 1) can use CXL BISnp operation to implement the BINVD operation to invalidate the PPE 118 at the host device 104. In other examples, in which the expansion device is a Type 2 CXL device, a device BIAS Flip via a CXL RdOwnNoData operation can be used to invalidate the PPE 118. In some examples, in response to CXL PPE invalidation, the host device 104 is configured to invalidate cache entries of the host PPE or invalidate structures (such as a PPT Lookaside Buffer (PLB), which can be a look-aside buffer that has a similar purpose to a translation look-aside buffer (TLB), but function against the PPT rather than a legacy page table) that contains a specified portion of the PPT. Device invalidation can be propagated to remote nodes if those nodes can cache the PPT 102, such as another device (e.g., CPU, for example). PLB is a non SRAM structure and follows or adheres to coherency rules.

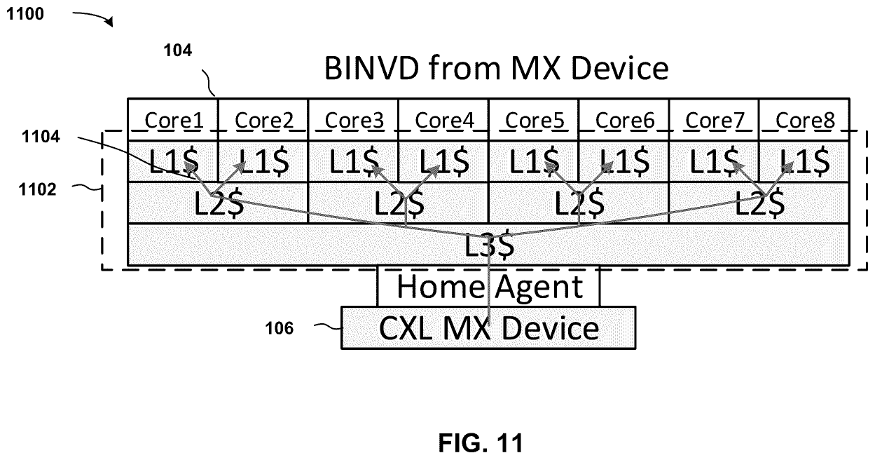

In some examples, the CXL device (the expansion device 106) can manage device DRAM paging. When the CMC 110 retires (removes) a page from DNM 114, any CL's associated to that page that are cached by the host cache memory 120 in a modified state can be demoted to a shared or invalid state using the CXL protocol. For example, a CXL 3.0 Type MX device as the expansion device 106 can issue a CXL BISnp instruction, which propagates through an entire cache hierarchy of the host device 104, resulting in back-invalidation of the entire cache hierarchy (e.g., invalidation of the host PPT). FIG. 11 is a simplified example of a H/W management technique 1100 for invalidating the cache hierarchy 1102 of the host device 104 entirely (or completely). As shown in FIG. 11, the cache hierarchy 1102 is fully invalidated by the issuance of the CXL BISnp instruction by the expansion device 106 as shown at 1104. Accordingly, in some examples, a CXL 3.0 Type 3 (e.g., 2-tier MX device) can be implemented as the expansion device 106 and can be configured to maintain data consistency via a BINVD instruction according to one or more examples, as disclosed herein.

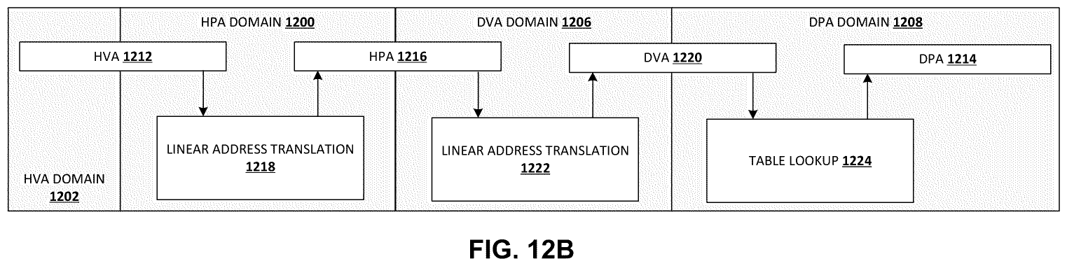

FIGS. 12A-12B is an example of using the PPT 102 or the PPE 118 for retrieving data stored on the expansion device 106, as shown in FIG. 1. Thus, reference can be made to one or more examples of FIGS. 1-11 (and in some instances one or more examples of FIGS. 13-26) in the example of FIGS. 12A-12B. FIG. 12A illustrates an HPA domain (or space) 1200 of the system 100, as shown in FIG. 1, or the computer system 200, as shown in FIG. 2. FIG. 12B is an example of transforming a HVA 1212 of the HPA domain 1200 to a DPA 1214 of a DPA domain 1208 using linear address translations and the DVA table 130.

The HPA Domain 1200 includes physical memory addresses that are available to the host device 104, such as for the DFM 112 for use. The host device 104 can map the DFM 112 into a system coherent address space. A HVA domain (space) 1202 can be configured for the application 106 (e.g., by the OS 132, as shown in FIG. 1), and the application 106 can operate within its own virtual address space. The host device 104 can translate the HVA 1212 in the HVA domain 1202 to a HPA 1216 in the HPA domain 1200, as shown in FIG. 12B. For instance, a memory request for data stored at the DFM 112 can be issued or generated by the application 106. The host device 104 (e.g., the core 204 of the host device 104) can use a linear address translation technique 1218 (e.g., algorithm) to transform the HVA 1212 to the HPA 1216. The host device 104 can evaluate (e.g., observe) the PPT 102 (or the PPE 118) to determine whether a page for accessing the data is present in a DPA domain (space) 1208. In the example of FIG. 12A, an observation is shown with a double-arrow at 1206. In response to the page being present in the DNM 114, the host device 104 can communicate with the expansion device 106 to retrieve data from or write data to a (HPA) memory location (or locations) in the expansion device 106. In response to the page being absent from the DNM 114, the host device 104 can communicate with the expansion device 106 to copy (or cache) data from the DFM 112, as indicated by a (HPA) memory location (or locations) to DNM 114 of the expansion device 106.

The host device 104 can forward (communicate) the memory request with the HPA 1216 to the expansion device 106. The HPA 1216 of the HPA domain 1200 can be translated to a DVA 1220 in a DVA domain (space) 1206. The CMC 110 of the expansion device 106 can translate the DVA 1220 to the DPA 1214 of the DPA domain (space) 1208. The CMC 110 can use a linear address translation technique 1222 (e.g., algorithm) to transform the HPA 1216 to the DVA 1220. The CMC 110 can use the DVA 1220 to lookup in the DVA table 130 a memory location within the DFM 112 at which the state is stored. The DVA table 130 can be implemented as a lookup table (LUT). The DVA table 130 can include the DPA 1214 identifying the memory location of the DFM 112 at which the data is stored. Thus, the CMC 110 can implement a table lookup technique to identify the memory location of the DFM 112 at which the data is stored. The expansion device 106 can provide the data that is stored at the memory location to the host device 104, and thus to the application 106.

In some examples, host supervisor-level (S/L) tasks can be given access to the PPT 102, in other examples, host user-level (U/L) tasks are given access to the PPT 102. Thus, in some examples, the host S/L tasks or the U/L tasks can cache the PPT 102 (e.g., in the host cache memory 120 or the host memory 122). For example, the host S/L tasks on the host device 104 can observe the PPT 102 directly and/or indirectly via S/L non-uniform memory access (NUMA) operational codes (opcodes), such as VRH (e.g., verify read hit) and VERRP (e.g., verify a segment for reading or writing). In some examples, the host S/L tasks on the host device 104 can modify the PPT 102 directly and/or via S/L NUMA opcodes. In some examples, program S/L data descriptor(s) can be set or defined to give the host S/L tasks appropriate read-only or read-write access to the PPT 102. In other or additional examples, a U/L task can indirectly observe the PPT 102 by using NUMA opcodes (e.g., host assembly language instructions). For a U/L task to execute these opcodes (on the host device 104), the U/L task can be granted read-only access to all or a portion of the PPT 102 via a data segment descriptor. If the NUMA opcodes execute in a U/L space without read-only permission to the PPT 102, a fault can occur. In some examples, the fault can be maskable. Program U/L data descriptor(s) can be used by the host device 104 to give host U/L tasks appropriate read-only or read-write access to the PPT 102.

The PPT 102 can be made coherent through use of the CXL protocol. In some examples, the host device 104 can cache the PPT 102 according to host PPT caching rules, as shown in table 1300. FIG. 13 illustrates a host PPT caching rules table 1300 for caching the PPT 102. FIG. 13 illustrates combinations of CR0 flags, MTRR and CR3 flags, as disclosed herein, for setting or determining a cacheability of the PPT 102 (e.g., in the host cache memory 120) at the host device 104. A first column of the table 1300 indicates a state of CD and NW bits (CR0 flags) of the CR0 register 220. When the CD and NW bits (flags) are clear (e.g., “0,0” as shown in the table 1300) caching of memory locations for a whole physical memory in a processor internal (external cache) is enabled. When the CD bit (flag) is set, caching is restricted. To prevent the host device 104 from accessing and updating its caches, the CD flag can be set, and the caches can be invalidated so that no cache hits can occur. When the NW and CD flags are clear, write-back or write-through can be enabled for writes that hit the cache, and invalidation cycles are enabled. A second column of the table 1300 specifies MTRR flags indicating a type of caching strategy that is to be used, such as uncacheable (UC), write-combining (WC), write-through (WT), writeback (WB), or write protect (WP) by the host device 104. A third column of the table 1300 indicates a memory type used to access the PPT 102 through use of the PCD and PWT flags of the CR3 register 222. A fourth column of the table 1300 indicates a memory type for host S/L task caching, and a fifth column of the table 1300 indicates a memory type for user S/L task caching.

Accordingly, in some examples, the host device 104 can cache the PPT 102 in its physical memory space according to the table 1300, as shown in FIG. 13. In some examples, the host device 104 can use custom high-speed structures called PPT Lookaside buffers (PLB's) to cache a portion of the PPT 102. The host device 104 can invalidate entries of the PLB's in response to the CXL BINVD instruction, for example, as disclosed herein. The host device 104, in some instances, can selectively cache PPT entries from the PPT 102 (e.g., CLs of the PPT 102) on behalf of either U/L or S/L tasks based on the host PPT caching rules. For example, if the kernel 210 instructs the host device 104 to set (or program) the CD and the NW bits of the CR0 register 220 to “0”, one of the MTRR 228 to “WB”, the PWT and the PCD bits to “0” of the CR3 register 222, this causes or results in the host device 104 caching PPT entries (CL entries) of the PPT 102 that are being accessed by S/L tasks, but not caching PPT entries being access by U/L tasks.

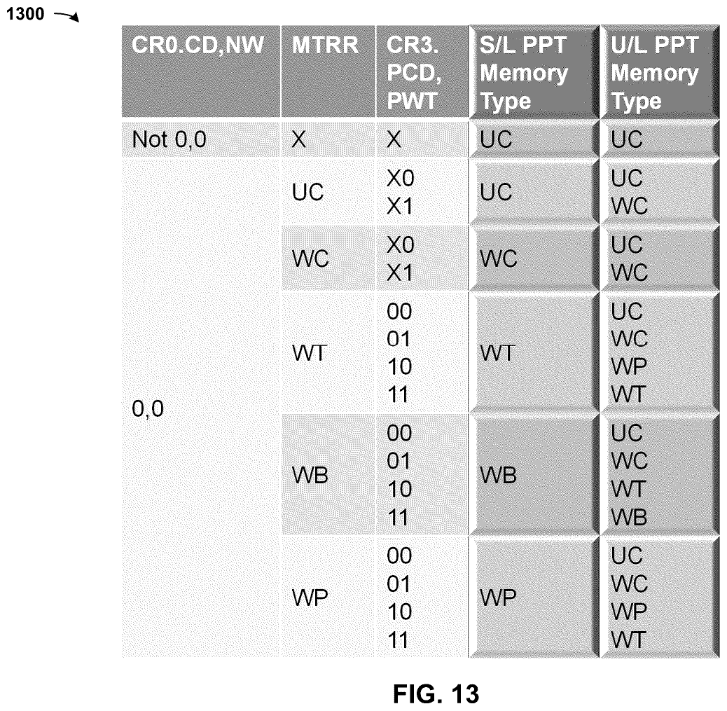

FIG. 14 is an example of the PPT 102, as shown in FIGS. 1-2. Thus, reference can be made to one or more examples of FIGS. 1-13 in the example of FIG. 14. Each bit of the PPT 102 indicates a presence or absence of a page of the DFM 112 in the DNM 114. A bit zero (0) indicates a page is not present, whereas a bit one (1) indicates a page is present in the PPT 102. The PPT 102 can be implemented as a bit-mapped array. Each entry of the PPT 102 identifies a page and wherein a bit is used to indicate whether that page is present or not present in the DFM 112, as shown in FIG. 1. For example, a cell 1402 of the PPT 102 holds a value (present indication bit) of either “1” or “0” to indicate whether page 1 is present or not present in the DNM 114. Thus, each cell in the PPT 102 can be representative of a page of the DNM 114. For example, the cell 1402 identifies “Page 1”. Thus, the PPT 102 identifies the pages 234 within the DFM 112, as shown in FIG. 2. Each entry (or cell) of the PPT 102 and thus bit value is mapped to a page identifier (hence the PPT is a bit-mapped array). The PPT 102 includes a number of presence indication bits. The number of presence indication bits in the PPT 102 is based on a number of memory pages, which can be referred to as “x” present in the DFM 112. Thus, the PPT 102 can include a number of bits based on the “x” number of memory pages 234 of DFM 112 to which each bit is mapped.

As shown in the example of FIG. 14, the PPT 102 can be organized (or grouped) into CL's and an entry for each CL holds a presence indication value (bit) and is associated with a corresponding page for the DFM 112. In some examples, the host device 104 that implements CXL works on CL's that are 64 bytes in size (or 512 bits). A CL is the smallest unit that can be transferred, and so, when the host device 104 wants to observe whether a page is present in memory, which requires 1 bit from the PPT 102 that bit is part of a 64 B CL. In some examples, a page size is 4 Kilobytes (KB), however, HPG supports other page sizes. In other examples, the PPT 102 can have a different cache line length (e.g., 32 bytes, 128 bytes, etc.). When the host device 104 reads an entry of the PPT 102 (for example, to fill the PPE 118), a full CL of the PPT 102 is read. For example, if the VMMU 212 receives data identifying page 1022 from the execution unit 206, or the host device 104 provides data identifying the page 1022, CL1 (as shown with a dashed rectangular box 1404 in the example of FIG. 14) is fully or completely read by the CMC controller 110 and delivered to the host device 104 (via the CXL protocol). In some examples, as disclosed herein, the host cache memory 120 or the PLB of the host device 104 can store a portion of the PPT 102, which is shown as the PPE 118 in the example of FIGS. 1-2. Thus, the PLB can store (cache) a page present entry. The PPE 118 (or the portion of the PPT 102) can correspond to one or more CLs of the PPT 102. For example, CL1, CL2 and CL3 can be stored on the host cache memory 120 as the PPE 118.

As disclosed herein, the expansion device 106 can provide the PPT 102. Page presence bit-fields of the PPT 102 can be assigned consecutively and contiguously to memory pages 234 of the DFM 112. The memory pages 234 can be enabled (e.g., mapped into HPA space) via CXL decoders 230 of the CXL protocol, as shown in FIG. 2. The CXL decoders 230 can be implemented at the expansion device 106. In the context of CXL, CXL decoders 230 can be responsible for interpreting and processing data and control signals that travel through a CXL bus, such as the bus 108. In some examples, the CXL decoders 230 can be implemented to be compatible with existing PCIe standards while providing additional features unique to CXL. This can ensure backward compatibility with legacy systems and scalability for future advancements in computing hardware. CXL supports different types of transactions for data transfer, control, and coordination between devices. These include memory read/write operations, data streaming, and command/control signals. CXL decoders are used to ensure that these transactions are correctly interpreted and executed.

For example, a least-significant bit (LSb) of CL0 of the PPT 102 can be assigned by the host device 104 to a first page (identified as “Page 0” in the PPT 102, as shown in FIG. 14) defined by a lowest enabled CXL decoder of the CXL decoders 230. In some examples, the host device 104 can configure the CXL decoders 230 such that device memory is not contiguous, and PPT entries of the PPT 102 can be noncontiguous. Page presence bits for Page 0—(n−1) of the PPT 102 can be associated with lowest enabled CXL decoder's n pages. Page presence bits of the PPT 102 for Page n—(n+m+1) can be associated with a next lowest enabled CXL decoder's m pages. This page presence bit and CXL enabled decoder association can continue until all enabled CXL decoders have been assigned to (or associated with) the PPT 102 by the host device 104. In some examples, if the host device 104 does not support discontinuous PPT ranges, the host device 104 can be configured to define more restrictive decoder programming models to prevent such configurations, which may be desirable in some implementations. Accordingly, the host device 104 can associate page presence bits of the PPT 102 with a corresponding enabled CXL decoder (page).

For example, the CXL decoders 230 can be implemented at a transaction layer of a CXL protocol stack at the host device 104. The CXL protocol stack can include a physical layer, a link layer, and a transaction layer. For example, the host device 104 (or the host system 202) can include one or more I/O interfaces (not shown in FIGS. 1-2) for implementing a respective instance of the protocol stack. Each I/O interface can include or be representative of input and output ports that enable the host device 104 to send and receive information/data to the expansion device 106, such as disclosed herein. The host device 104 (or the host system 202) can include any number of I/O interfaces based on an application (e.g., layout, architecture, systems, etc.) for communicating information/data to and from one or more expansion devices. In some examples, the protocol stack can be a combination of software, firmware, and hardware implemented at the host device 104 to enable the host device 104 to communicate with the expansion device 106. In some examples, the protocol stack can be configured to provide for a high-speed CPU-to-device or CPU-to-memory interconnect that can be based on utilizing elements of an interconnect platform or architecture (e.g., PCIe). The protocol stack can be configured to maintain memory coherency between a host memory space and memory on the expansion device 106 (e.g., DFM 112), which allows resource sharing for higher performance, reduced stack complexity, and lower overall system cost, and among other advantages.

In some examples, the protocol stack can be configured to establish a CXL link between the host device 104 and the expansion device 106. A protocol stack can be implemented at the expansion device 106 to receive the CXL link or allow for the establishment of the CXL link. The CXL link can support dynamic protocol multiplexing of coherency, memory access, and I/O protocols. CXL provides a set of protocols that include I/O semantics that may be similar to PCIe, caching protocol semantics, and memory access semantics over a discrete or on-package link. Based on application, all of the CXL protocols or only a subset of the protocols may be enabled. In some implementations, CXL may be built upon a PCIe infrastructure (e.g., PCIe 5.0), leveraging the PCIe physical and electrical interface to provide advanced protocols in areas including I/O, memory protocol (e.g., allowing a host device to share memory with an expansion device), and coherency interface.

The CXL protocol can include a CXL IO (CXL.io) protocol, a CXL cache (CXL.cache) protocol, and a CXL.memory (CXL.mem) protocol. The CXL.io protocol can be a non-coherent load/store interface for I/O devices (e.g., the expansion device 106, as shown in FIGS. 1-2). Transaction types, transaction packet formatting, credit-based flow control, virtual channel management, and transaction ordering rules in CXL.io may follow all or a portion of a PCIe definition. The CXL.mem protocol can be a transactional interface between the host device 104 and the expansion device 106. The CXL.mem protocol can be used for different memory types (volatile, persistent, etc.) and configurations (flat, hierarchical, etc.). The CXL.cache protocol can be a cache interface that defines interactions between the host device 104 and the expansion device 106.

In some examples, the host device 104 can include coherence/cache logic representative of a coherency/cache engine and interconnect logic representative of an interconnect engine. In some examples, the CXL.cache and CXL.memory protocols can include respective interfaces representative of cache and memory channels. Each channel can be independently accessed for a transaction (e.g., sending of messages). The cache and memory channels can be established between the coherency/cache engine and the transaction layer such as the transaction layer to send and receive cache and memory messages (e.g., access or memory requests). In a non-limiting example, the cache channels can include three (3) channels in each direction for sending responses, requests, and data, which can be referred to herein as messages.

In some examples, the protocol stack 102 includes circuitry for implementing multiplexing logic to enable multiplexing of CXL protocols (e.g., CXL.io, CXL.cache, and CXL.mem protocols). For example, the link layer or an intermediate layer employed between the link layer and the physical layer can be provided to implement multiplexing of the CXL protocols. Thus, messages of any one of the CXL protocols can be sent in a multiplex manner using the CXL link to the expansion device 106. In some examples, the host device 104 (or the host system 202) can include a Flex Bus™. A Flex Bus port is a flexible high-speed that can be configured to statically support either a PCIe or a CXL link. The Flex Bus port can be used to establish the CXL link to the expansion device 106, which in some examples, can be an accelerator (e.g., an FPGA accelerator), or a memory extender device, such as the expansion device 106.

By way of example, one or more messages (or memory requests (e.g., to read or write data) generated at the host device 104 can be provided to the protocol stack. The transaction layer of the protocol stack can be configured to packetize the messages into transaction layer (TL) packets. A respective message of the messages is stored as a payload in a respective TL packet. As the TL packets are moved down the protocol stack to the link layer and then to the physical layer, the TL packets can be extended with information to handle packets at those layers. The physical layer can be configured to transmit symbols representative of packets over the bust 232 to a physical layer of a protocol stack being implemented at the expansion device 104. There, a reverse process can occur, and the information added to the packets can be removed (e.g., stripped) as the packets move up the protocol stack at the expansion device 106. A transaction layer of the protocol stack of expansion device 106 can deliver a payload of the packets to a destination (e.g., the CMC controller 110).

In some examples, in which the protocol stack is implemented at the I/O interface of the host system 202, the transaction layer can be configured to provide an interface between the host device 104 and the link layer. In this regard, the link layer can be configured to receive messages from at least one of the three CXL protocols (e.g., that have been enabled) from the host device 106. For example, the coherency/cache engine can be configured to provide cache or memory messages via respective established cache and/or memory channels to the transaction layer. The transaction layer can be configured to packetize the messages from the cache and/or memory channels into packets referred to as TL packets and provide the TL packets to the link layer. The transaction layer can append TL header information during TL packetization of messages. A packet format for TL packets generated by the transaction layer can be found in a PCIe specification. In some examples, the link layer can be configured to receive the TL packets. The link layer can be employed to provide reliable data transfer between protocols. The link layer can rely on the physical layer to frame physical layers unit of transfer into link layers unit of transfer.

In some examples, the physical layer can include a logical sub layer and an electrical sub layer to transmit a data stream that includes LL packets to the expansion device 106. The logical sub layer can be configured to prepare outgoing data, such as each LL packet, for transmission by the electrical sub layer. In some examples, the logical sub-layer can be configured to prepare and identify received data, such as provided by the device, before passing the data to the link layer. The logical sub layer can be configured to frame the LL packets with start transaction data (in some examples other data) and generate framed packets. The framed packets can be transmitted by the electrical sub layer as a data stream to the expansion device 106 using the link over the communication channel 108.

In some examples, the electrical sub layer can include a transmitter and a receiver. The logical sub-layer can be configured to provide the transmitter with symbols representative of the framed packets. The transmitter can be configured to serialize the symbols to generate the data stream and transmit the serialized symbols using the link to the expansion device 106. In some examples, the host device 104 (or the I/O interface) can be configured to generate serialized symbols and transmit the serialized symbols using the established link to the expansion device 106 in a same or similar manner as described herein. The receiver can be configured to receive the serialized symbols and transform the serialized symbols into a bitstream. The bitstream can be de-serialized by the electrical sub layer and supplied to the logical sub layer. The logical sub layer can be configured to provide the bitstream up the protocol stack for processing to communicate messages in the bitstream to the host device 104.

In some examples, as a two-tier (2-tier) CXL expansion device (MX device), the expansion device 106 can provide at least two (2) CXL memory address decoders. One memory decoder can be used by the host device 104 to map the PPT 102 to the host device 104. A remaining decoder can be used by the host device 104 to map user capacity of the expansion device 106 (or the DFM 112) into the HPA space of the host device 104. In some examples, a first field of particular type of control and status register(s) (CSR) of the host device 104 (which can be referred to as a “PPT_Dec_N field” in some instances) can be configured to indicate which memory decoder(s), or CXL decoders (Decoder 0−n, wherein “n” is a number of decoders) are associated with the PPT 102. The host device 104 can be configured to write the PPT_Dec_N field prior to enabling an associated decoder. In some examples, the CSR register corresponds to one of the system registers 218, in some instances, as described herein.

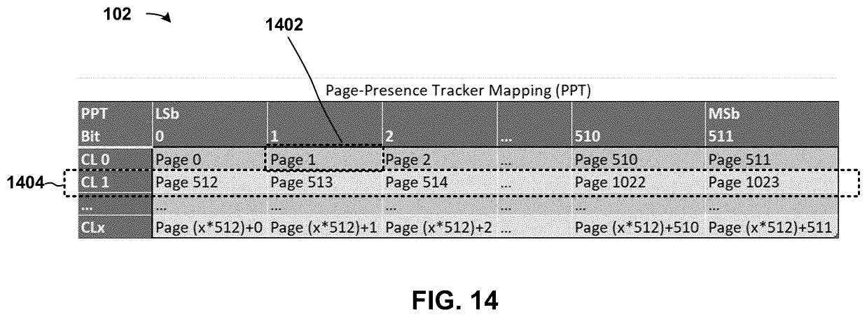

FIGS. 15-22 illustrates mappings of a respective DPA space of DFM of one or more expansion devices into the HPA space of the host device 104. In some examples, one of the one or more expansion devices (or at least two of these devices) can be implemented similar to the expansion device 106, or correspond to the expansion device 106, as shown in FIGS. 1-2. Thus, reference can be made to one or more examples of FIGS. 1-14 in the examples of FIGS. 15-22. In the example of FIGS. 15-22, an expansion device is referred to as a “CMC”.

FIG. 15 is an example of mapping a DPA space 1502 into a host memory map (HPA space) 1504 of the host device 104. As shown in the example of FIG. 15, a single CXL decoder of the CXL decoders 230 can be used by the host device 104 to map the DPA space 1502 of the DFM 112 into the HPA space 1504. In the example of FIG. 15, all of the DPA space 1502 of the DFM 112 is mapped into the HPA space 1504 with one (1) decoder.

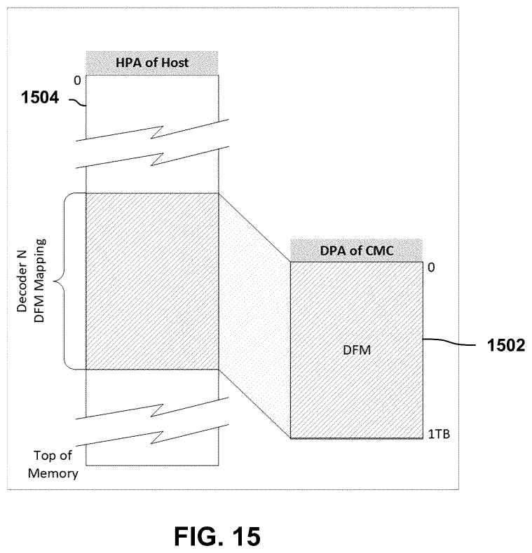

FIG. 16 is an example of mapping two (2) DPA spaces 1602-1604 into the HPA space 1606 of the host device 104 in a non-contiguous manner. As shown in the example of FIG. 16, 2 CXL decoders can be used by the host device 104 to map a first DPA space 1602 of the DFM and a second DPA space 1604 of the same CMC into the HPA space 1606 of the host device 104 in a non-contiguous manner. In the example of FIG. 16, the first and second DPA spaces 1602-1604, which are contiguous in DPA space, are mapped into the HPA space 1606 such that the first and second DPA spaces 1602-1604 are non-contiguous in the HPA space 1603.

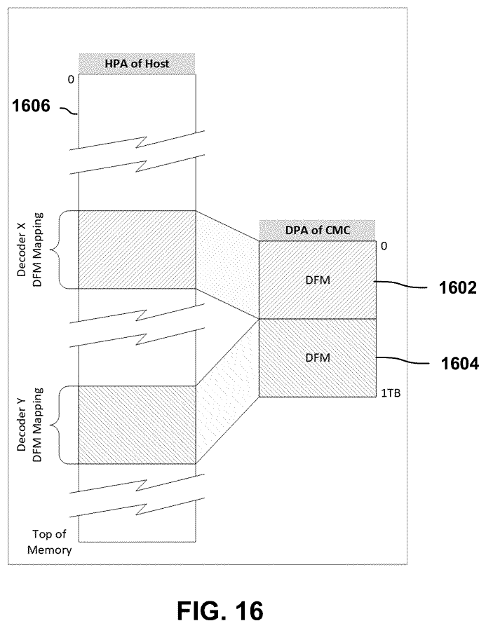

FIG. 17 is an example of mapping two (2) DPA spaces 1702-1704 into the HPA space 1706 of the host device 104. As shown in the example of FIG. 17, 2 CXL decoders can be used by the host device 104 to map a first DPA space 1702 of a first CMC (e.g., a first expansion device) and a second DPA space 1704 of a second CMC (e.g., a second expansion device) into the HPA space 1706 of the host device 104. In the example of FIG. 17, the first and second DPA spaces 1702-1704 are mapped into the HPA space 1706 such that these DPA spaces are contiguous in the HPA space 1706.

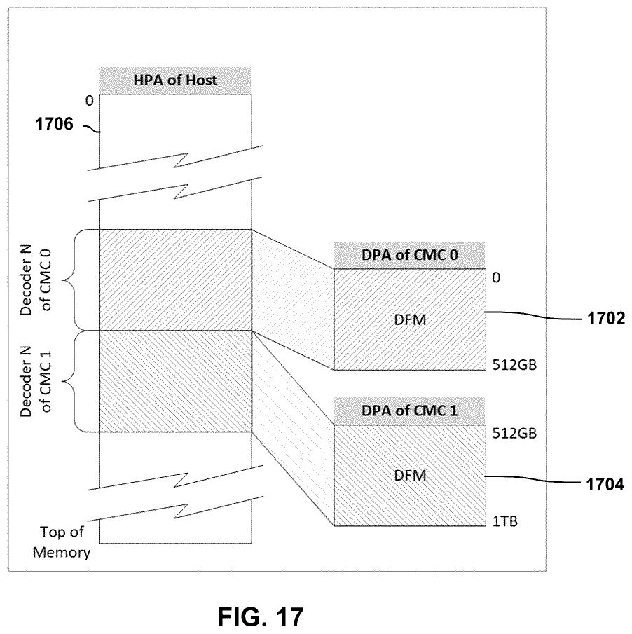

FIG. 18 is an example of mapping a DPA space 1802 into the HPA space 1804 of the host device 104. The host device 104 can map the CMC's entire DFM space of the DFM 112 of the expansion device 106 into a single (one area) of the HPA space 1804, as shown in FIG. 18. This results in a continuous PPT at the HPA space 1804, as shown at 1806.

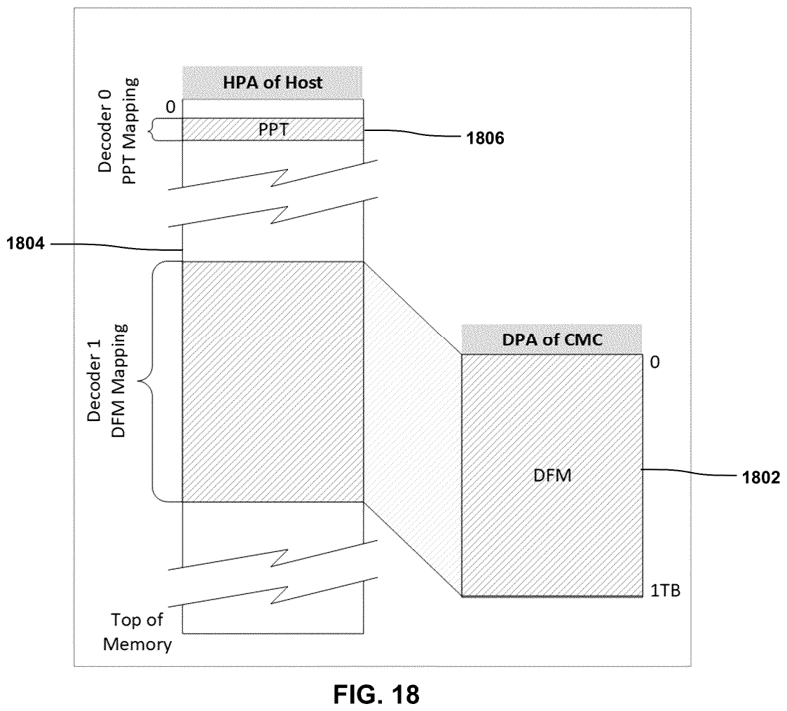

FIG. 19 is an example mapping two (2) DPA spaces 1902-1904 into the HPA space 1906 that is continuous. The host device 104 can map first and second DPA spaces 1902-1904 of first and second DFM of respective first and second CMC's (e.g., first and second expansion devices) into the HPA space 1906. In the example of FIG. 19, the host device 104 has mapped two (2) CMC's memory capacity contiguously into the HPA space 1906. The host device 104 has also mapped each CMC's PPT contiguously into the HPA space 1906 as well. This results in a continuous and contiguous PPT at the HPA space 1906, as shown at 1908.

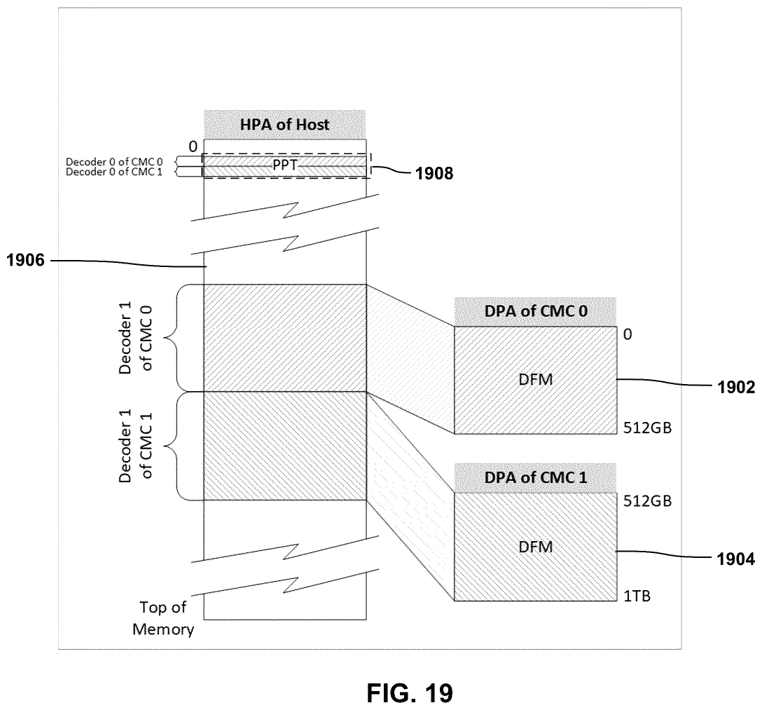

FIG. 20 is an example of mapping two contiguous (2) DPA spaces 2002-2004 of a CMC into the HPA space 2006 of the host device 104 that is non-contiguous. The host device 104 has also mapped the CMC's PPT into the HPA space 2008. This results in a non-continuity in the PPT array at the HPA space 2006. For example, a first section of PPT maps decoder 1 pages and a second section of PPT maps decoder 2 pages. As such, the mapping example of FIG. 20, results in a discontinuity in PPT address mapping, which is shown with a dashed-line and identified with reference numeral 2010.

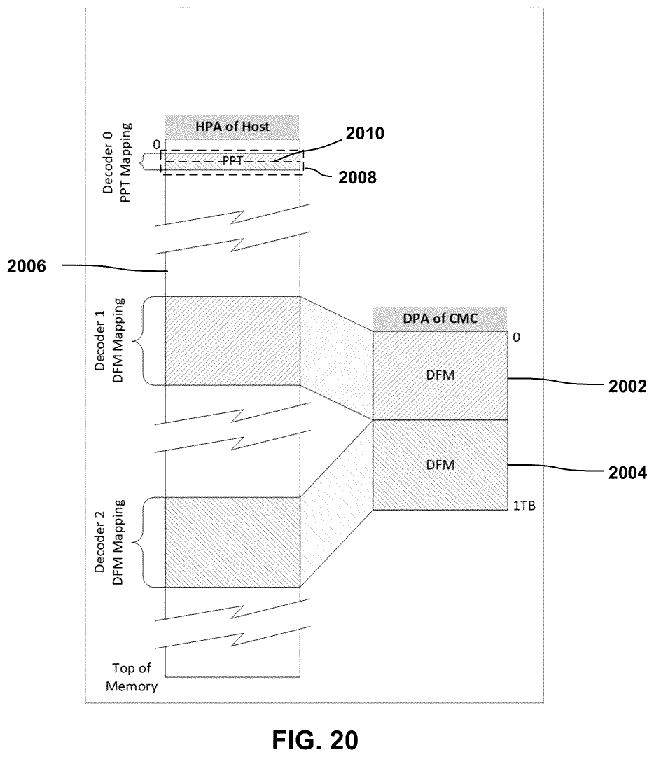

FIG. 21 is an example of mapping two (2) DPA spaces 2102-2104 of two CMCs into the HPA space 2106 of the host device 104 that is non-contiguous. The host device 104 has also mapped the PPT of each CMC contiguously into the HPA space 2108. This results in a non-continuity in the PPT array at the host HPA space 2106. For example, a first section of PPT maps decoder 1 pages and a second section of PPT maps decoder 2 pages. As such, the mapping example of FIG. 21, results in a discontinuity in PPT address mapping, which is shown with a dashed-line and identified with reference numeral 2110.

The examples of FIGS. 20-21 result in a discontinuity in a PPT addressing mapping and thus a first PPT entry for a second DFM space is not mapping a next linear page directly following a last PPT entry for a first DFM space.

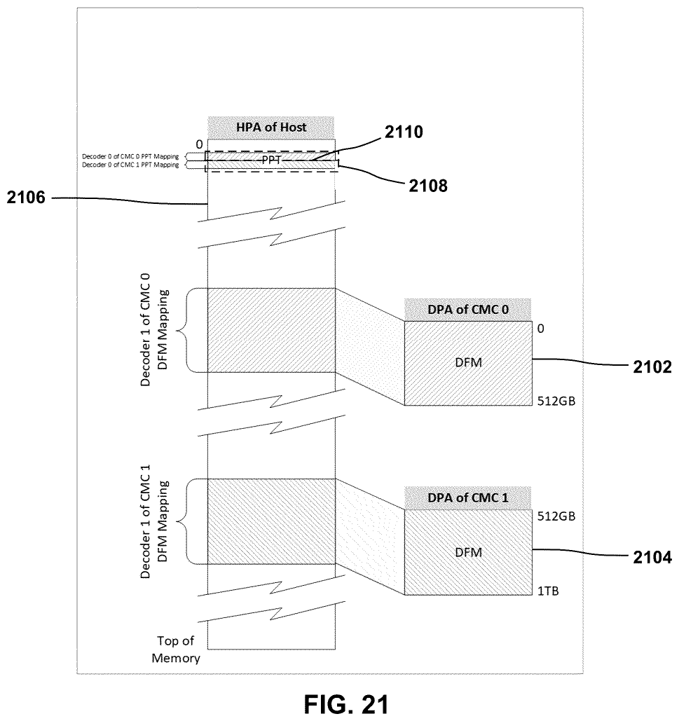

FIG. 22 is an example of mapping two (2) DPA spaces 2202-2204 into the HPA space 2206 of the host device 104 contiguously. For example, the host device 104 can map first and second DPA spaces 2202-2204 contiguously into the HPA space 2206. The host device 104 can assign first and second PPT decoders to be mapped the PPTs of each CMC non-contiguously, as shown at 2210.

Accordingly, in examples in which there are multiple or more than one expansion device, the host device 104 can be configured to expose a PPT of each of the expansion devices to the HPA space using a CXL decoder (e.g., a CXL decoder capability structure). In some examples, the DFM of expansion devices can be interleaved by the host device 104. To interleave the DFM of the expansion devices, the expansion devices have to be similar expansion devices. In some examples, PPT decoder rules can be defined for interleaving PPT tables. The host device 104 can be configured to set a similar user capacity for all of the same expansion devices. The host device 104 can also be configured to set PPT page granularity to be the same for all of these expansion devices. The host device 104 is configured to interleave the PPT tables as a single (1) interleave set. An interleave granularity in some examples can match a page size.

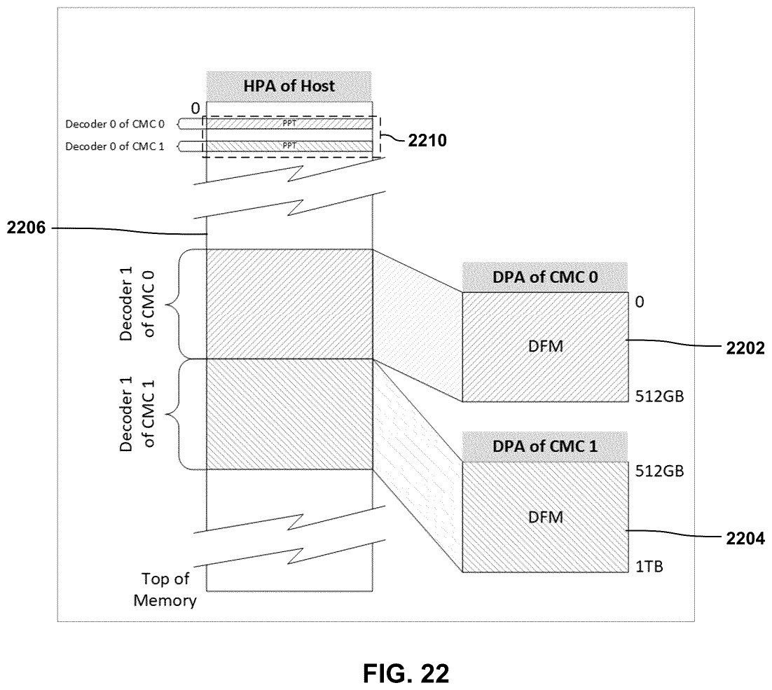

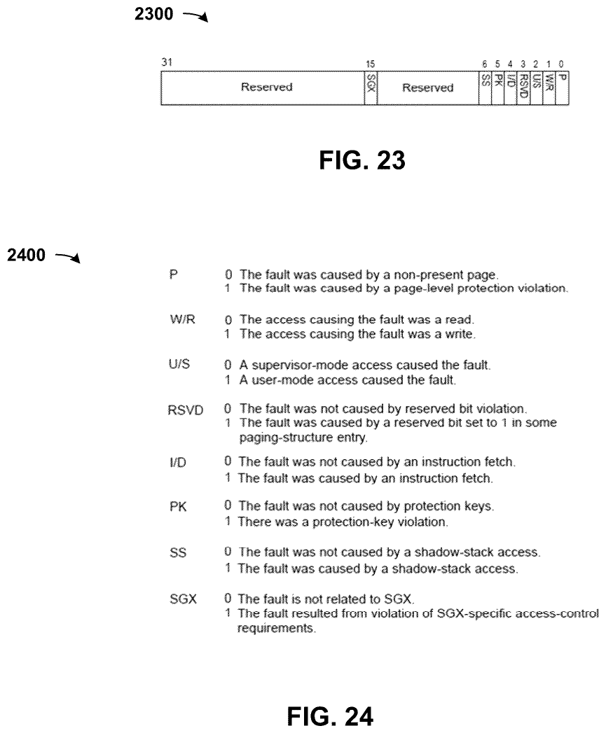

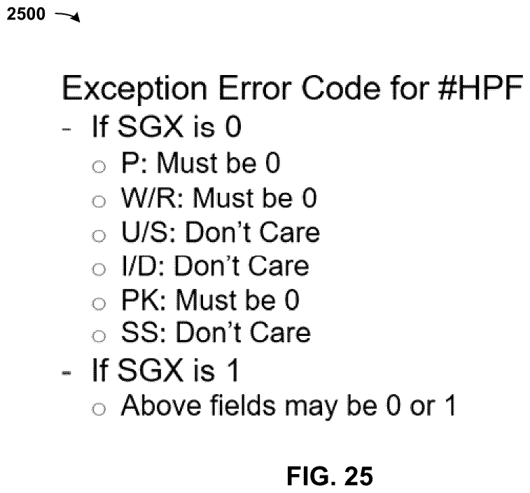

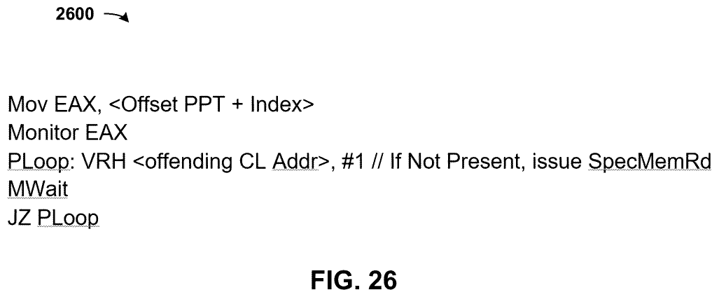

In some examples, the host device 104 can read a linear address whose associated PPT page entry in the PPT 102 (e.g., a page presence bit) indicates that a page is not present (e.g., a bit value of zero) can generate a page fault, in some instances referred to as a hybrid page fault. The page faults can invalidate any PLB's and caches containing the page that is not present. In some examples, the page fault invokes Exception #14. A CR2 register of the system registers 218 can contain a linear address that caused the fault. FIG. 23 is an example of a CR2 register bit map table 2300. FIG. 24 is an example of a CR2 register bit description table 2400. FIG. 25 is example pseudocode 2500 for configuring bits of the CR2 register for invoking a page fault (e.g., Exception #14). The pseudocode 2500 can be implemented as machine-readable instructions and in some instances can be implemented as part of the kernel 210, as shown in FIG. 2. The kernel 210 can use the pseudocode 2500 to instruct the host device 104 to set (or configure) the particular bits of the CR2 register identified by the pseudocode 2500. In some examples, the kernel 210 can include a hybrid page fault handler 214, as shown in FIG. 2. The hybrid page fault handler 214 can be implemented as machine readable instructions and cause a device-specific low-latency communication mechanism to report the page fault to the expansion device 106. FIG. 26 is an example of pseudocode 2600 for implementing the hybrid page fault handler 214. This mechanism can be provided as an Input/Output Control (IOCTL) via a CXL device driver.

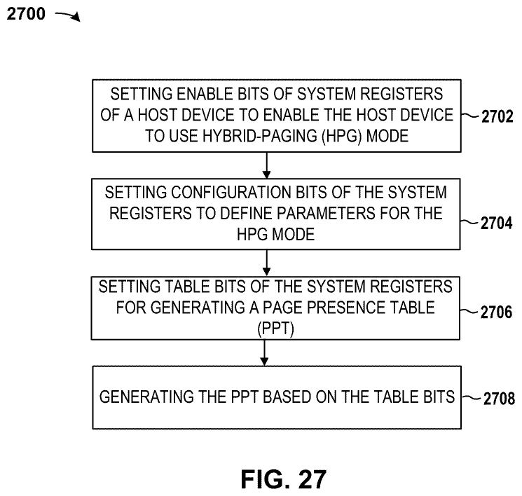

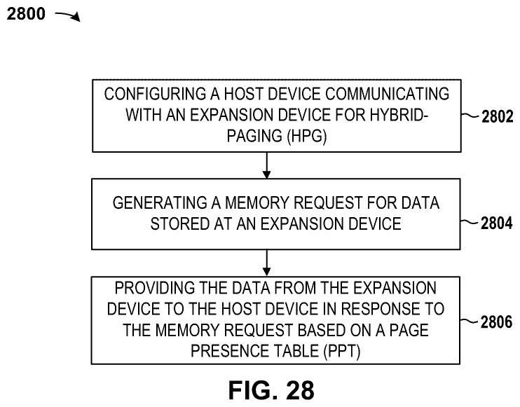

In some examples, the host device 104 can issue or generate a NUMA instruction. For example, the NUMA instruction can be a verify read hit instruction (e.g., “VRH r/m64, imm8” instruction). The instruction can provide a test condition for a DRAM hit and set one or more status flags in EFLAGs according to the results. For example, a ZF flag can be set to zero (0) to indicate presence and to one (1) to indicate absence. The operand “r/m64” provides a linear address to test, and the operand “imm8” issues a CXL MemSpecRd on Absent Condition instruction. In some examples, the host device 104 (e.g., a core) interrogates the PPT 102 to determine whether the page is present or absent. On a miss, the host device 104 issues a Spec Read instruction if operand 2==“1”. The expansion device 106 (e.g., MX device) treats the MemSpecRd instruction as a prediction and can fetch the page into DRAM (the DFM 112). In view of the foregoing structural and functional features described above, an example method will be better appreciated with reference to FIGS. 27-28. While, for purposes of simplicity of explanation, the example methods of FIGS. 27-27 are shown and described as executing serially, it is to be understood and appreciated that the present examples are not limited by the illustrated order, as some actions could in other examples occur in different orders, multiple times and/or concurrently from that shown and disclosed herein. Moreover, it is not necessary that all described actions be performed to implement the methods.

FIG. 27 is an example of a method 2700 for enabling or configuring a host device (e.g., the host device 104, as shown in FIGS. 1-2) to operate in a HPG mode. For example, the method 2700 can be implemented by the host device 104, as shown in FIGS. 1-2. Thus, reference can be made to one or more examples of FIGS. 1-26 in the example of FIG. 27. The method 2700 can begin at 2702 by setting enable bits of system registers (e.g., the system registers 218, as shown in FIG. 2) of the host device to configure the host device to operate in a HPG mode. At 2704, setting configuration bits of the system registers to define operational parameters for the HPG mode. At 2706, setting table bits of the system registers for generating a PPT (e.g., the PPT 102, as shown in FIGS. 1-2). At 2708, generating the PPT based on the table bits. The PPT can be used to optimize data access from an expansion device (e.g., the expansion device 106, as shown in FIG. 1) for the host device.

FIG. 28 is an example of a method 2800 for accessing data from an expansion device (e.g., the expansion device 106, as shown in FIGS. 1-2) using HPG. For example, the method 2800 can be implemented by the system 100, as shown in FIG. 1 or the computer system 200, as shown in FIG. 1. Thus, reference can be made to one or more examples of FIGS. 1-27 in the example of FIG. 28. The method 2800 can begin at 2802 by configuring a host device (e.g., the host device 104, as shown in FIGS. 1-2) communicating with an expansion device (e.g., the expansion device 106, as shown in FIGS. 1-2) for HPG. In some examples, step 2802 can include the method 2700, as shown in FIG. 27. At 2804, generating a memory request for the data stored at the expansion device. The expansion device can include Tier 1 memory (e.g., DNM 114, as shown in FIG. 1) and a Tier 2 memory (e.g., the DFM 112, as shown in FIG. 1). The Tier 1 memory functions as a cache for the Tier 2 memory based on a PPT (e.g., the PPT 102, as shown in FIGS. 1-2). The PPT can indicate a presence of Tier 2 pages in the Tier 1 memory. A HPA of a memory request can be converted to a DVA using linear transformation. The DVA can be converted to a DPA using a DVA table (e.g., the DVA table 130, as shown in FIG. 1). The DVA table can include the DPA identifying a memory location of the Tier 1 memory at which the data is stored. At 2806, the method 2800 can include providing the data from the expansion device to the host device in response to the memory request based on the PPT.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 5-10% of the indicated number.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

The invention claimed is:

1. A method for configuring a host device for hybrid-paging (HPG) comprising:
setting enabling bits of system registers of the host device to configure the host device to operate in a HPG mode;
setting configuration bits of the system registers to define operational parameters for the HPG mode;
setting table bits of the system registers for generating a page presence table (PPT); and
generating the PPT based on the table bits, the PPT being used to access data at an expansion device for the host device.

2. The method of claim 1, further comprising storing the PPT at the expansion device, wherein the host device observes the PPT for accessing the data from the expansion device for the host device.

3. The method of claim 2, further comprising storing a portion of the PPT at the host device as a page presence entry.

4. The method of claim 2, further comprising:
storing a copy of the PPT at the host device; and
maintaining PPT coherency between the PPT stored at the expansion device and the copy of the PPT stored at the host device.

5. The method of claim 4, wherein the PPT coherency is maintained using Compute Express Link (CXL).

6. The method of claim 1, wherein kernel configuration code is executed by the host device to instruct the host device to configure the enabling, configuration, and table bits of the system registers.

7. The method of claim 1, wherein the enabling bits include a page (PG) bit of a CR0 register of the system registers and a HPG bit of a CR4 register of the system registers.

8. The method of claim 1, wherein the configuration bits include a write protect (WP) bit of the CR0 register, a physical address extension (PAE) bit, a page global enable (PGE) bit, a process-context identifier enable (PCIDE) bit, a supervisor mode execution protection (SMEP) bit, a supervisor mode access prevention (SMPA) bit, a protection key supervisor (PKE) bit, and a protection key enable (PKE) bit of a CR4 register of the system registers.

9. The method of claim 1, wherein the table bits further include a host page fault mask (GW) bit of the CR4 register, the GW bit being used to control based on which operation at the host device a page fault is generated.

10. The method of claim 1, wherein the table bits further include memory granularity (MG) bits and host physical memory address (HPA) bits of a CR3 register of the system registers, the base HPA bits identifying a base HPA address for the PPT, and the MG bits specifying a page granularity for the PPT.

11. The method of claim 1, wherein the table bits further include page-level cache disable (PCD) and a page-level write through (PWT) bits of CR3 register that specify a memory type that is used by the host device to access the PPT.

12. The method of claim 1, wherein the table bits further include a PPT mask register (PPTMASK) bits of a CR5 register that specify a size of the PPT.

13. The method of claim 12, further comprising computing the size of the PPT based on a memory capacity of the expansion device and a page granularity for the PPT.

14. The method of claim 1, wherein the host device includes memory type range registers (MTRR) and the MTRR are used to control a caching behavior of the host device for caching the PPT in cache memory.

15. A method for accessing data for a host device from an expansion device comprising:
configuring the host device for hybrid-paging (HPG);
generating a memory request for the data stored at the expansion device, the expansion device comprising first memory and second memory, wherein the first memory functions as a cache for the second memory based on a page presence table (PPT), the PPT indicating a presence of memory pages in the first memory for the second memory,
converting a host physical memory address (HPA) of the memory request to a device virtual memory address (DVA);
converting the DVA to a device physical memory address (DPA) to identify a memory location within the first memory at which the data is stored; and
providing the data to the host device based on the identified memory location.

16. The method of claim 15, further comprising:
asserting a page fault in response to determining that a memory page for the memory request is not present in the first memory;
loading the memory page into the first memory in response to the page fault being asserted; and
updating a page presence bit for the memory page in the PPT to indicate that the memory page is present in the first memory.

17. The method of claim 15, wherein the page fault is asserted by one of the host device and the expansion device.

18. The method of claim 15, wherein configuring the host device for HPG comprises:
setting enabling bits of system registers of the host device to configure the host device to operate in a HPG mode;
setting configuration bits of the system registers to define operational parameters for the HPG mode;
setting table bits of the system registers for generating the PPT; and
generating the PPT based on the table bits.

19. A system comprising:
a host device that communicates with an expansion device, the host device being configured to execute configuration code to set bits of system registers of the host device to configure the host device for hybrid paging (HPG);
wherein configuring the host device for HPG comprises generating a page presence table (PPT) in response to executing the configuration code, the PPT indicating a presence of memory pages in a first memory of the expansion device for second memory of the expansion device, and
wherein the host device is configured to receive the data stored at the expansion device based on the PPT.

20. The system of claim 19, wherein the first memory is Tier 1 memory, the second memory is Tier 2 memory, and the Tier 1 memory is a cache for the Tier 2 memory.

21. An expansion device comprising:
first memory;
second memory;
a page presence table (PPT), the PPT indicating a presence of one or more pages of the second memory in the first memory;
a device virtual memory address (DVA) table specifies a placement of the one or more pages of the second memory in the first memory, and a device physical memory address (DPA) identifying a memory location in the second memory for accessing data; and
a cache memory controller to manage access to the data in the second memory based on the PPT and the DVA table.

22. The expansion device of claim 21, wherein the cache memory controller is to implement address translation to translate the host physical memory address (HPA) into the DPA for accessing the data in the DNM.
